(19) United States
(12) Patent Application Publication
(10) Pub. No.: US 2019/0266575 A1
(43) Pub. Date: Aug. 29, 2019

(54) MODIFYING FIELD WORKFLOWS

(71) Applicant: Honeywell International, Inc., Morris Plains, NJ (US)

(72) Inventors: Rohan McAdam, Yetholme (AU); Graeme Laycock, Hunters Hill (AU); Akshay Saini, Ryde (AU)

(21) Appl. No.: 15/906,472

(22) Filed: Feb. 27, 2018

(51) Int. Cl. G06Q 10/00; G06Q 10/06

(52) U.S. Cl. CPC G06Q 10/20; G06Q 50/04; G06Q 10/06316; G06Q 10/06312

(57) ABSTRACT

Systems, apparatuses, and methods are described for integrating production process information into field worker mobile workflows in a plant, such as a petrochemical manufacturing or refining facility. A field worker mobile device may receive a mobile workflow of a scheduled series of actions corresponding to completion of a maintenance task associated with a piece of equipment, such as a pressure swing adsorption (PSA) unit, commonly used in many petrochemical and refinery processes. The mobile device also may receive operating limits for a measureable element of the equipment, such a threshold pressure value. When a current operating condition of the measurable element of the petrochemical manufacturing or refining facility fails to meet the operating limits, the mobile workflow may be automatically modified, based on equipment sensor data, to an alternate mobile workflow in connection with corrective action to address the failure.

### FIELD

The disclosure relates generally to a method and system for managing the operation of a plant, such as a chemical plant or a petrochemical plant or a refinery, and more particularly to a method for improving the performance of components that make up operations in a plant.

### BACKGROUND

Industrial process control and automation systems are often used to automate large and complex industrial processes. Industrial processes are typically implemented using large numbers of devices, such as pumps, valves, compressors, or other industrial equipment used to implement various aspects of the industrial processes. With these large numbers of devices, scheduled or responsive maintenance needs to be efficient in order to maintain overall efficiency of a plant.

### SUMMARY

The following summary presents a simplified summary of certain features. The summary is not an extensive overview and is not intended to identify key or critical elements.

Numerous devices in these types of systems may generate operational, diagnostic, or other data and transmit the data to other components for analysis, storage, or other uses. For example, at least some of this data may be used to identify issues in control and automation systems or in the underlying industrial processes. Maintenance personnel or other personnel may then be dispatched to repair or replace equipment or take other suitable corrective actions to resolve the issues. Similar operations may occur in other systems that include large numbers of devices, such as building management systems.

Working effectively in an industrial enterprise fundamentally requires that field workers know what tasks to perform and how to perform them. Furthermore, workers require additional information about the current production process or business situation that may affect the tasks to be performed and the specific procedures to be followed. Mobile workflow solutions provide field workers with explicit step-by-step instructions on the procedures that need to be performed. However, in addition to knowing what to do and how to do it, field workers also need to take current manufacturing process conditions into account that may affect the tasks to be performed and the specific procedures to be followed. Some systems make it hard for field workers to know what additional process information is relevant to the activities they are engaged in, access the information when needed, and know how to modify their activities accordingly.

This disclosure provides for modifying a mobile workflow on a mobile device for the presentation of a series of actions related to an industrial process, control and automation system, or other system. This disclosure integrates production process information in mobile workflows used by field operators so that field activities become sensitive to production process requirements and conditions, including corrective actions to be taken when process conditions are outside normal conditions requiring a deviation from standard field procedures.

Other technical features may be readily apparent to one skilled in the art from the following figures, descriptions, and claims.

### BRIEF DESCRIPTION OF DRAWINGS

The present disclosure is illustrated by way of example and not limited in the accompanying figures in which like reference numerals indicate similar elements and in which:

FIG. 1 depicts a schematic of an adsorption vessel for a pressure swing adsorption unit in accordance with one or more example embodiments;

FIG. 2 depicts an illustrative pressure swing adsorption unit for a hydrogen purification process in accordance with one or more example embodiments;

FIG. 3A-3E each depict steps of operation of a pressure swing adsorption unit for a hydrogen purification process in accordance with one or more example embodiments; FIG. 3F depicts the pressure of each step over time;

FIG. 4A depicts an illustrative computing environment for managing the operation of one or more pieces of equipment in a plant in accordance with one or more example embodiments;

FIG. 4B depicts an illustrative data collection computing platform for collecting data related to the operation of one or more pieces of equipment in a plant in accordance with one or more example embodiments;

FIG. 4C depicts an illustrative data analysis computing platform for analyzing data related to the operation of one or more pieces of equipment in a plant in accordance with one or more example embodiments;

FIG. 4D depicts an illustrative data analysis computing platform for analyzing data related to the operation of one or more pieces of equipment in a plant in accordance with one or more example embodiments;

FIG. 4E depicts an illustrative control computing platform for controlling one or more parts of one or more pieces of equipment in a plant in accordance with one or more example embodiments;

FIG. 5 depicts an illustrative computing environment for managing the operation of one or more pieces of equipment in a plant in accordance with one or more example embodiments;

FIG. 6 depicts an illustrative example computing device supporting augmented field workflows to an industrial process, control and automation system, or other systems according to this disclosure;

FIGS. 7A-7B depict illustrative data flows of one or more steps that one or more devices may perform in controlling one or more aspects of a plant operation in accordance with one or more example embodiments;

FIG. 8 depicts an illustrative flow diagram of one or more steps that one or more devices may perform in controlling one or more aspects of a plant operation in accordance with one or more example embodiments; and

FIGS. 9A-9G depict illustrative dashboards for viewing information and/or taking actions related to one or more aspects of a plant operation in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure. Further, various connections between elements are discussed in the following description. It is noted that these connections are general and, unless specified otherwise, may be direct or indirect, wired or wireless, and that the specification is not intended to be limiting in this respect.

A chemical plant or a petrochemical plant or a refinery may include one or more pieces of equipment that process one or more input chemicals to create one or more products. References herein to a “plant” are to be understood to refer to any of various types of chemical and petrochemical manufacturing or refining facilities. References herein to a plant “operators” are to be understood to refer to and/or include, without limitation, plant planners, managers, engineers, technicians, technical advisors, specialists (e.g., in instrumentation, pipe fitting, and welding), shift personnel, and others interested in, starting up, overseeing, monitoring operations of, and shutting down, the plant.

A piece of equipment commonly used in many petrochemical and refinery processes is a pressure swing adsorption (PSA) unit. Adsorption is the preferential partitioning of substances from the gaseous or liquid phase onto the surface of a solid substrate (adsorbent). Most PSA units are used to recover and purify hydrogen process streams such as from hydrocracking and hydrotreating process streams. But PSA units may also be used to recover and purify helium, methane, monomer, chlorine, and carbon dioxide. Most hydrogen PSA unit applications are used for steam methane reformers, refinery off-gas (Platforming, HC, etc.), and ethylene off-gas. PSA units may accept feeds with purities from about 35% up to 99% and may be designed for a very wide range of product rates.

A typical PSA unit may have a control system containing hardware, software, and human-machine interface for operator interface, and a valve skid containing control valves, piping, and instrumentation. The devices in the valve skid communicate with the control system to operate the PSA. The PSA unit also contains multiple adsorber vessels and a tail gas surge tank. The adsorber vessels contain adsorbents.

There may be any number of adsorber vessels depending on the plant design, for example at least 3 and up to 20 adsorber vessels, often referred to as beds—e.g., a 6 bed polybed PSA unit or a 10 bed polybed PSA unit. Parameters that are monitored include feed source, feed pressure, feed capacity, recovery, and purity. Loading refers to the quantity of adsorbed material per mass unit of adsorbent. In this one example, any of a number of measurable elements of a PSA may be measured for a current operating condition data, such as current temperature, current pressure, current level, current flow, current density). The current operating condition may be monitored and maintained over time, whether periodically or upon request. Whether requested or periodically, the current operating condition may be stored as current asset condition data, e.g., the current temperature for a particular asset, e.g., PSA unit, may be stored.

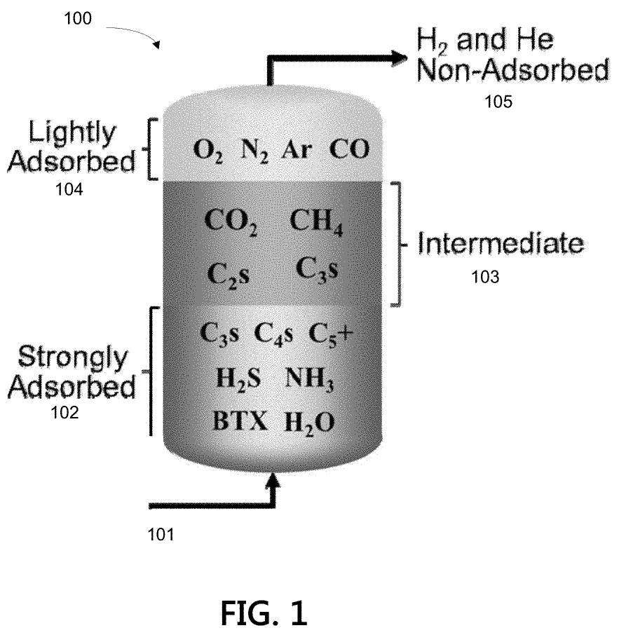

FIG. 1 represents flow through an adsorber vessel 100 during adsorption. The feed gas 101 is introduced into the bottom of the adsorber vessel and contacts the adsorbent. Impurities are removed down to any level required. Heavy components as those that are strongly adsorbed (C₄+, H₂S, NH₃, BTX and H2O) are removed in the bottom portion of the bed (with a weak adsorbent) 102. Intermediate components, such as CO, CH₄, CO₂, Cas, and Cas, are removed in the middle of the bed 103. Light components are more difficult to adsorb (e.g., require a very strong adsorbent) 104. Examples are: O₂, Ar, and N₂. These components are removed at the top of the bed, and the separation is keyed on the lightest (or most difficult to adsorb) component. H₂ and He are essentially non-adsorbed 105.

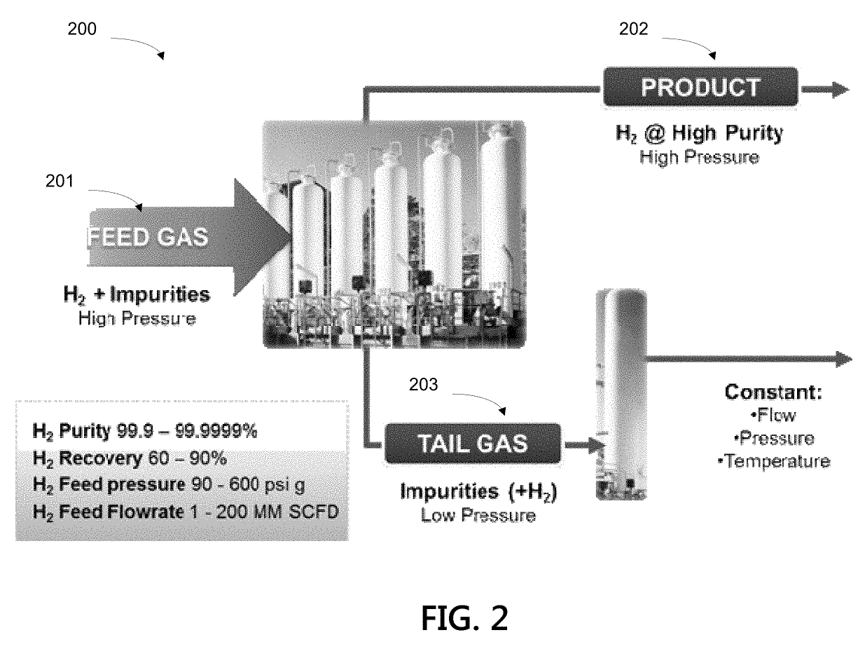

The PSA unit relies on a pressure swing cycle and the ability of adsorbents to adsorb more impurities at high pressure than at low pressure. FIG. 2 depicts a PSA basic flow diagram 200. Feed 201 enters at high pressure, constant flow rate, constant pressure, and constant temperature. Product (e.g., high purity H₂) 202 leaves at high pressure, constant flow rate, constant pressure, and constant temperature. In time, the adsorbent becomes saturated with impurities 203 and the impurities must be removed.

Hydrogen recovery (%) is the quantity of hydrogen in the product stream divided by the quantity of hydrogen in the feed stream. Generally, the higher the number of adsorber units, the greater the % hydrogen recovery. Recovery is maximized through pressure equalizations.

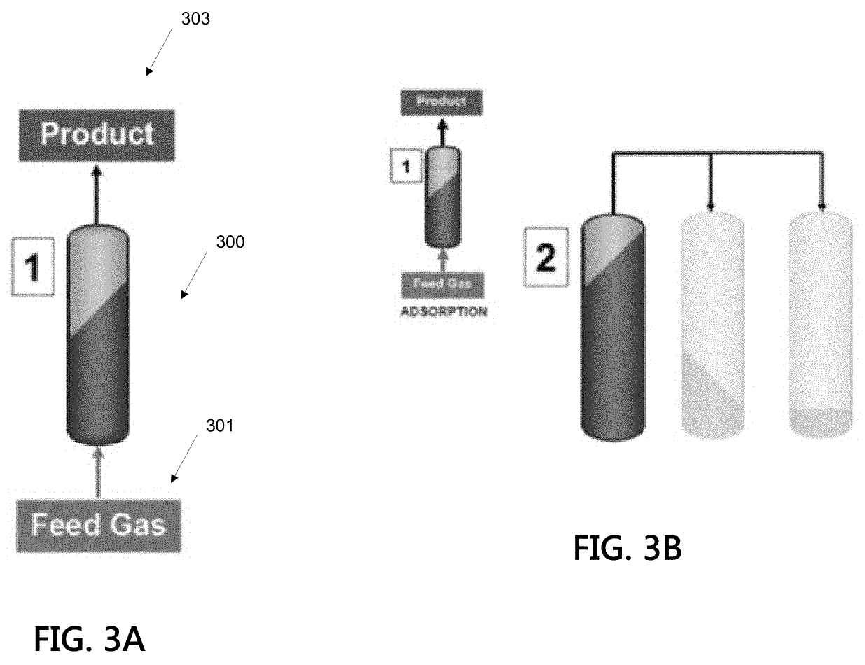

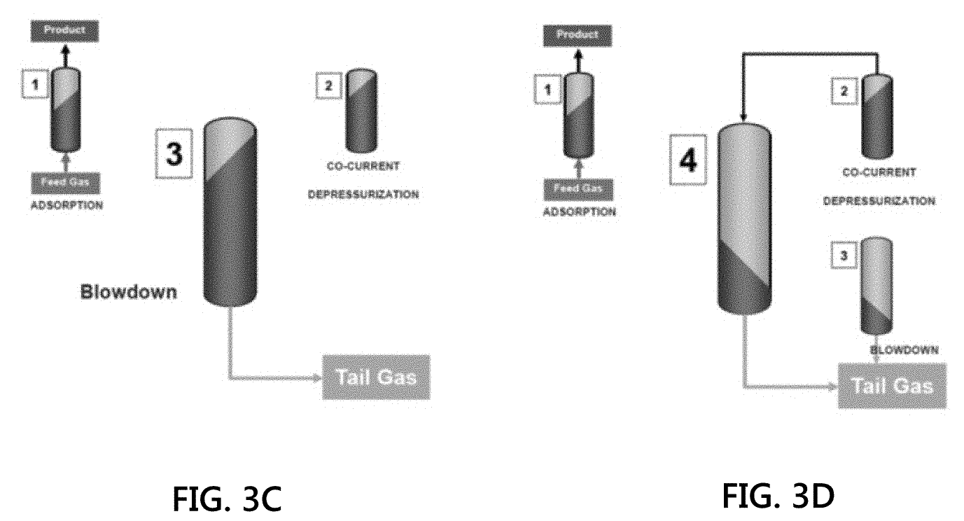

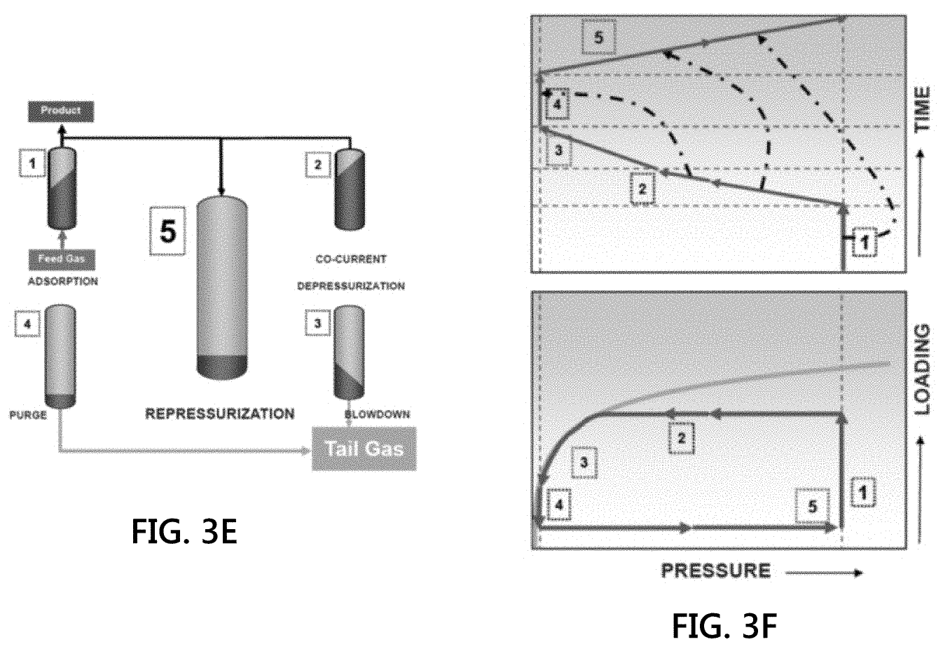

FIGS. 3A-3E depict steps in a typical PSA process and FIG. 3F depicts pressure and loading over time for each step. Steps 1 to 5 (adsorption, co-current depressurization, counter-current depressurization, purge, re-pressurization) are indicated in boxes having the corresponding numbers in FIGS. 3A-3F. As shown in FIG. 3A, step 1, feed gas 301 flows through an adsorber 300 whereby impurities are adsorbed onto the adsorbent and product 303 exits at the top. See FIG. 2, described above. Pressure increases as loading increases in the adsorber vessel as seen in FIG. 3F. Once the adsorbent is saturated with impurities, the adsorption step is discontinued. As shown in FIG. 3B, step 2, and FIG. 3F pressure is equalized by passing the hydrogen stream over to one or more adsorber vessels via co-current depressurization and purging of the adsorber vessel. As shown in FIG. 3C and FIG. 3F, step 3, pressure is decreased in the adsorber vessel via counter-current depressurization or blowdown. This step removes the impurities from the adsorber unit. As shown in FIG. 3D and FIG. 3F, step 4, the adsorber vessel is purged using co-current depressurization with another adsorber vessel. The product from the blow down of step 3 and the purge of step 4 is tail gas, which may be sent to a burner. As shown in FIG. 3E and FIG. 3F, step 5, the adsorber vessel is repressurized.

The off-gas or tail gas stream from a PSA operates at varying flow and composition; hence a surge tank is utilized to dampen flow fluctuations caused by the cyclic nature of the process and provide mixing. The resulting tail gas stream is a constant flow, pressure, temperature off-gas, usually at low pressure. Although the PSA is a cyclic process, the product and tail gas streams are uninterrupted and at constant pressure and flowrate. The feed gas and hydrogen product stream operate at nearly the same pressure. The impurities and some unrecovered hydrogen are rejected at low pressure. The pressure of the tail gas generally has a strong impact on the efficiency of the PSA unit, and hence may be monitored and current operating conditions of the PSA unit may be stored in a memory.

An impurity level signal is used to adjust the operation of the PSA unit for optimum recovery, product purity, and maximum capacity. The system maintains product purity by taking automatic corrective action to the unit's operation before significant levels of impurities may break through into the product gas (feed forward control). For each cycle, a self-tuning function monitors and adjusts the initial opening values of certain valves (e.g., PP, BD, Rep) to maintain the most efficient operation. The self-tuning function may adjust for positioner drift, changes in the flow characteristic from the vessels, etc.

The PSA unit may be designed to automatically pressurize each vessel for start-up. Auto pressure start-up helps ensure the smoothest possible start-up with the least operator intervention by automatically ramping each adsorber to the appropriate start-up pressure. Included in automatic capacity control is automatic tail gas flow adjustment to minimize fluctuations in tail gas flow and pressure.

A PSA unit may produce very high purity hydrogen, typical total impurity levels in the product are between 1000 and 10 ppm, or even lower impurity levels. But the process must be carefully monitored in order to achieve and maintain such purity levels.

The process of adsorption and desorption occurs quite rapidly, e.g., every 90 seconds. Hence, the pressure in each adsorber vessel increases and decreases rapidly and the valves used in the process must cycle on and off continuously and quickly. As many adsorber vessels may be used in a PSA unit, many valves are utilized in the process. Ideally, such valves operate in an efficient manner. The valves control the drastic changes in pressure that occurs in each adsorber vessel. Each adsorber vessel utilizes 3 to 5 valves, for example. Each valve cycles 100,000 to 200,000 cycles per year. Thus, the process is very abusive on the valves. The specialized valves contain soft seals that break down over time and need to be replaced or rebuilt. Sometimes the valves will stick open or closed, resulting in a significant rock to the system.

Often the system will be operated until one or more valves fail, at which point the system may need to be taken offline at an inopportune time in the process. This is not efficient and may be expensive and wasteful. Further, the catalysts or adsorbents should be replaced prior to saturation; otherwise, if catalysts or adsorbents become deactivated or saturated, contaminants will not be removed and the desired purity of the hydrogen stream will not be achieved.

The present disclosure is directed to repairs and maintenance for equipment designed for processing or refining materials like catalyst or adsorbents (e.g., equipment such as valves, rotating equipment, pumps, heat exchangers, compressors, gates, drains, and the like). The system may be configured to take one or more actions, such as sending one or more alerts or sounding one or more alarms if certain conditions are met, as well as instructions for maintenance or repair of a piece of equipment. Additionally, this disclosure is directed to compiling and analyzing operational performance data and efficiently presenting this data (e.g., to a user) to improve system operations and efficiency with a step-by-step workflow on a mobile device that may be modified (e.g., partway through the workflow) depending on certain asset operation conditions occurring at the time of maintenance or repair.

Suitable sensors include pressure sensors, temperature sensors, flow sensors for feed and product streams, chemical composition analyzers, and liquid level sensors. In some examples, any of a number of such sensors may be positioned throughout a PSA unit. In addition, control valves and valve-position sensors may be positioned in a PSA unit. Other sensors may be used, such as moisture sensors/analyzers, infrared cameras, and/or tunable laser diodes.

In some embodiments, the system may include analyzers on the Feed, Product, and/or Tail Gas lines in order to feed composition data into an analytics engine (e.g., a data analysis platform). Some embodiments may include one or more gas chromatographs to monitor the composition of each of the feed, product, and/or tail gas streams. The online gas chromatographs may enable accurate and timely composition data into the analytics engine, which may increase the accuracy of the analytics calculation. One or more additional metrics and/or features may also be included.

In some plants, an operational objective may be to improve PSA unit operation on an ongoing and consistent basis. Therefore, a system may deliver timely and/or regular reports indicating current operating conditions, along with interpretation and consulting on what actions may be performed to improve PSA unit performance.

Some plants routinely require technical support in the operation of the plant. Many of these plant operators perform little to no past/present/future analysis on the operation of their plant. This disclosure may solve both of those problems by analyzing plant data and incorporating algorithms and rules to proactively manage the plant and provide notice and step-by-step instructions for replacing or repairing assets like catalysts or adsorbents.

The disclosure ties together plant information with big data and analytics. The disclosure may also empower review of real plant data, which may allow for more accurate fault models based on, e.g., catalyst adsorbent materials. Ultimately, the disclosure may result in a more robust product tailored for a specific plant with the ability to provide and modify mobile workflows for workers in the plant based upon conditions (e.g., real-time or nearly real-time conditions) of the assets under review for repair or maintenance. The advantages that may be achieved are numerous and rooted in both new product development and optimization of plants.

The present disclosure incorporates technical service know-how and utilizes automated rules. The present disclosure provides assurance that a unit is operating at optimum purity/recovery while protecting adsorbent load, including capacity/purity monitoring; unit on-stream percentage; switchover history/time in each mode; process alarm tracking and diagnostics; and/or dashboard links to electronic operating manual. The present disclosure also provides maximizing on-stream time by recording, identifying, and/or scheduling maintenance activities, including valve cycle count and time since last maintenance; identifying suspected leaking valves; advanced valve diagnostics (e.g., open/close speed, overshoot, etc.); vessel cycle count; spare parts information/ordering support; and/or control panel software updates. The present disclosure also provides quick resolution of unplanned downtime, including a technical service group having access to internal dashboard for each plant, including access to preconfigured trends, displays, and/or historical data.

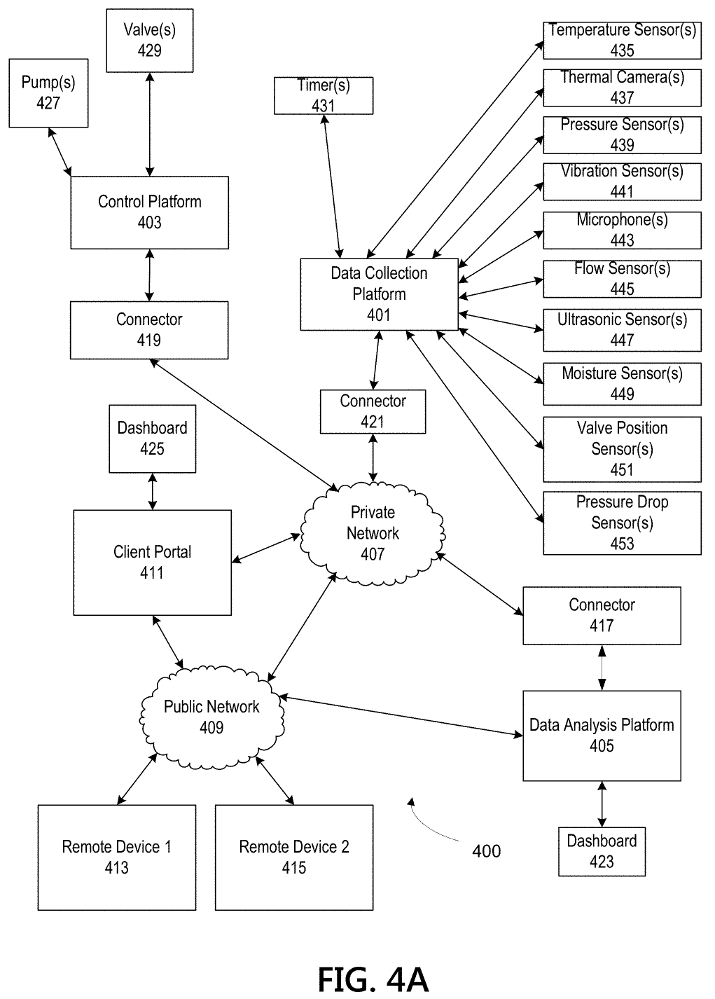

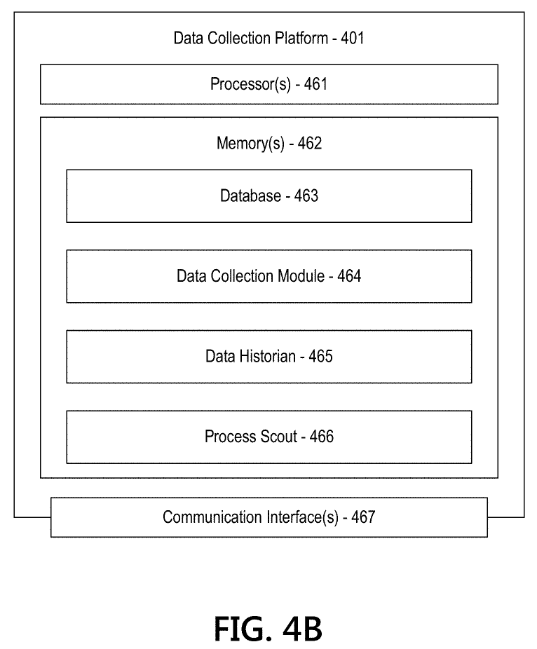

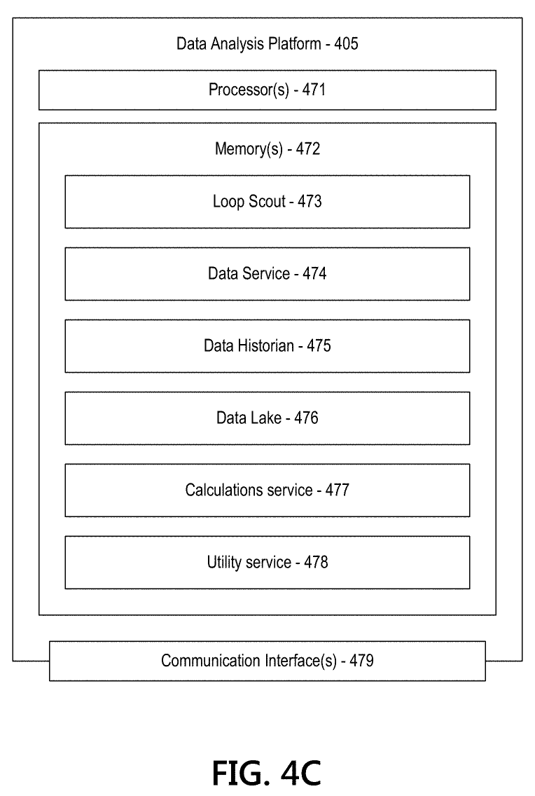

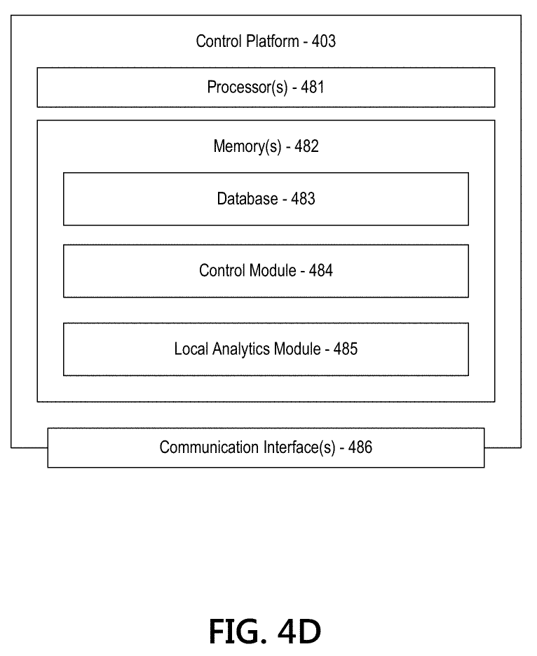

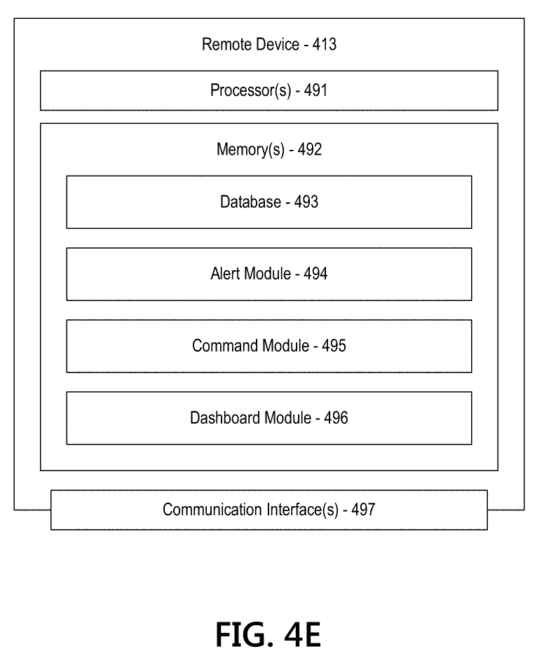

The system may include one or more computing devices or platforms for collecting, storing, processing, and analyzing data from one or more sensors. FIG. 4A depicts an illustrative computing system 400 that may be implemented at one or more components, pieces of equipment (e.g., PSA units), and/or plants. FIG. 4A-FIG. 4E (hereinafter collectively “FIG. 4”), show, by way of illustration, various components of the illustrative computing system in which aspects of the disclosure may be practiced. It is to be understood that other components may be used, and structural and functional modifications may be made, in one or more other embodiments without departing from the scope of the present disclosure. Moreover, various connections between elements are discussed in the following description, and these connections are general and, unless specified otherwise, may be direct or indirect, wired or wireless, and/or combination thereof, and that the specification is not intended to be limiting in this respect.

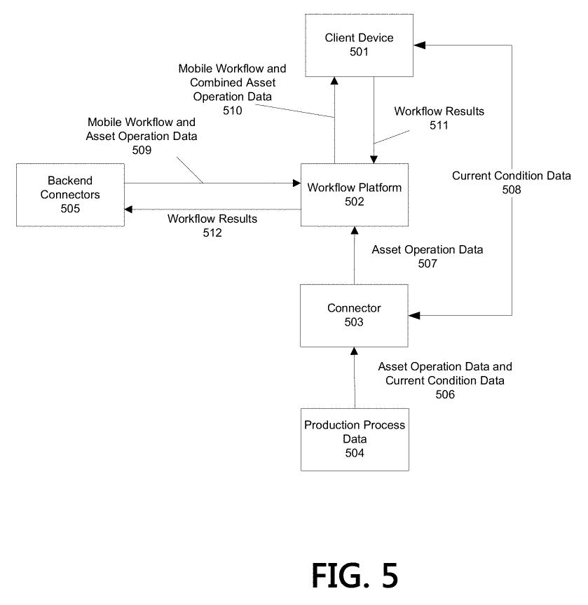

FIG. 4A depicts an illustrative operating environment 400 in which various aspects of the present disclosure may be implemented in accordance with example embodiments. The computing system environment illustrated in FIG. 4A is only one example of a suitable computing environment and is not intended to suggest any limitation as to the scope of use or functionality contained in the disclosure. FIG. 5 is another illustrative operating environment in which various aspects of the present disclosure may be implemented in accordance with example embodiments. The computing system environment of FIG. 4A may include various sensor, measurement, and data capture systems, a data collection platform 401, a data analysis platform 405, a control platform 403, a client portal 411, one or more networks 407 and 409, one or more remote devices 413 and 415, one or more connectors 417, 419, and 421 and/or one or more other elements. The numerous elements of the computing system environment 400 of FIG. 4A may be communicatively coupled through one or more networks. For example, the numerous platforms, devices, sensors, and/or components of the computing system environment may be communicatively coupled through a private network 407. The sensors may be positioned on various components in the plant and may communicate wirelessly or wired with one or more platforms illustrated in FIG. 4A. The private network 407 may comprise, in some examples, a network firewall device to prevent unauthorized access to the data and devices on the private network. Alternatively, the private network 407 may be isolated from external access through physical means, such as a hard-wired network with no external, direct-access point. The data communicated on the private network 407 may be optionally encrypted for further security. Depending on the frequency of collection and transmission of sensor measurements and other data to the data collection platform 401, the private network 407 may experience large bandwidth usage and may be technologically designed and arranged to accommodate for such technological issues. Moreover, the computing system environment 400 may also include a public network that may be accessible to remote devices 413 and 415. In some examples, the remote device 413 and 415 may be located not in the proximity (e.g., more than one mile away) of the various sensor, measurement, and data capture systems illustrated in FIG. 4A. In other examples, the remote device 413 and 415 may be physically located inside a plant, but restricted from access to the private network 407; in other words, the adjective “remote,” need not necessarily require the device to be located at a great distance from the sensor systems and other components.

Although the computing system environment of FIG. 4A illustrates logical block diagrams of numerous platforms and devices, the disclosure is not so limited. In particular, one or more of the logical boxes in FIG. 4 may be combined into a single logical box or the functionality performed by a single logical box may be divided across multiple existing or new logical boxes. For example, aspects of the functionality performed by the data collection platform 401 may be incorporated into one or each of the sensor devices illustrated in FIG. 4A. As such, the data collection may occur local to the sensor device, and the enhanced sensor system may communicate directly with one or more of the control platform 403 and/or data analysis platform 405. Such an embodiment is contemplated by FIG. 4A. Moreover, in such an embodiment, the enhanced sensor system may measure values common to a sensor, but may also filter the measurements such just those values that are statistically relevant or of-interest to the computing system environment are transmitted by the enhanced sensor system. As a result, the enhanced sensor system may include one or more processor (or other circuitry that enables execution of computer instructions) and one or more memories to store those instructions and/or filtered data values. The processor(s) may be embodied as an application-specific integrated circuit (ASIC), FPGA, or other hardware- or software-based module for execution of instructions. In another example, one or more sensors illustrated in FIG. 4A may be combined into an enhanced, multi-purpose sensor system. Such a combined sensor system may provide economies of scale with respect to hardware components such as processors, memories, communication interfaces, and others.

In yet another example, the data collection platform 401 and data analysis platform 405 may reside on a single server computer or virtual machine and be depicted as a single, combined logical box on a system diagram. Moreover, one or more data stores may be illustrated in FIG. 4A separate and apart from the data collection platform 401 and data analysis platform 407 to store a large amount of values collected from sensors and other components. The data stores may be embodied in a database format and may be made accessible to the public network 409; meanwhile, the control platform 403, data collection platform 401, and data analysis platform 405 may be restricted to the private network 407 and left inaccessible to the public network 409. As such, the data collected from a plant may be shared with users (e.g., engineers, data scientists, others), a company's employees, and even third parties (e.g., subscribers to the company's data feed) without compromising potential security requirements related to operation of a plant. The databases may be accessible to one or more users and/or remote devices 413 and 415 over the public network 409.

Referring to FIG. 4A, process measurements from various sensor and monitoring devices may be used to monitor conditions in, around, and on process equipment (e.g., PSA units). Such sensors may include, but are not limited to, pressure sensors 439, differential pressure sensors, other flow sensors 445, temperature sensors 435 including thermal cameras 437 and skin thermocouples, pressure drop sensors 453, capacitance sensors, weight sensors, gas chromatographs, moisture sensors 449, ultrasonic sensors 447, position sensors 451, timing sensors 431, vibration sensors 441, level sensors, liquid level (hydraulic fluid) sensors, and other sensors commonly found in the refining and petrochemical industry. Further, process laboratory measurements may be taken using gas chromatographs, liquid chromatographs, distillation measurements, octane measurements, and other laboratory measurements. System operational measurements also may be taken to correlate the system operation to the PSA unit measurements.

In addition, sensors may include transmitters and deviation alarms. These sensors may be programmed to set off an alarm, which may be audible and/or visual. Other sensors may transmit signals to a processor or a hub that collects the data and sends to a processor. For example, temperature and pressure measurements may be sent to a hub (e.g., data collection platform). In one example, temperature sensors may include thermocouples, fiber optic temperature measurement, thermal cameras, and/or infrared cameras. Skin thermocouples may be applied to tubes or placed directly on a wall of an adsorption unit. Alternatively, thermal (infrared) cameras may be used to detect temperature (e.g., hot spots) in one or more aspects of the equipment, including tubes. A shielded (insulated) tube skin thermocouple assembly may be used to obtain accurate measurements. One example of a thermocouple may be a removable XTRACTO Pad. A thermocouple may be replaced without any additional welding. Clips and/or pads may be utilized for ease of replacement. Fiber Optic cable may be attached to a unit, line, or vessel to provide a complete profile of temperatures.

Furthermore, flow sensors 445 may be used in flow paths such as the inlet to the path, outlet from the path, or within the path. If multiple tubes are utilized, the flow sensors may be placed in corresponding positions in each of the tubes. In this manner, one may determine if one of the tubes is behaving abnormally compared to other tubes. Flow may be determined by pressure-drop across a known resistance, such as by using pressure taps. Other types of flow sensors include, but are not limited to, ultrasonic, turban meter, hot wire anemometer, vane meter, Kármán™, vortex sensor, membrane sensor (membrane has a thin film temperature sensor printed on the upstream side, and one on the downstream side), tracer, radiographic imaging (e.g., identify two-phase vs. single-phase region of channels), an orifice plate in front of or integral to each tube or channel, pitot tube, thermal conductivity flow meter, anemometer, internal pressure flow profile, and/or measure cross tracer (measuring when the flow crosses one plate and when the flow crosses another plate).

Moisture level sensors 449 may be used to monitor moisture levels at one or more locations. For example, moisture levels at an outlet may be measured as a measurable element. Additionally, moisture levels at an inlet of the PSA unit or adsorption vessel may be measured. In some embodiments, a moisture level at an inlet may be known (e.g., a feed is used that has a known moisture level or moisture content). A gas chromatograph on the feed to the PSA unit may be used to speciate the various components to provide empirical data to be used in calculations.

Sensor data, process measurements, and/or calculations made using the sensor data or process measurements may be used to monitor and/or improve the performance of the equipment and parts making up the equipment, as discussed in further detail below. For example, sensor data may be used to detect that a desirable or an undesirable chemical reaction is taking place within a particular piece of equipment, and one or more actions may be taken to encourage or inhibit the chemical reaction. Chemical sensors may be used to detect the presence of one or more chemicals or components in the streams, such as corrosive species, oxygen, hydrogen, and/or water (moisture). Chemical sensors may utilize gas chromatographs, liquid chromatographs, distillation measurements, and/or octane measurements. In another example, equipment information, such as wear, efficiency, production, state, or other condition information, may be gathered and determined based on sensor data.

Corrective action may be taken based on determining this equipment information. For example, if the equipment is showing signs of wear or failure, corrective actions may be taken, such as taking an inventory of parts to ensure replacement parts are available, ordering replacement parts, and/or calling in repair personnel to the site. Certain parts of equipment may be replaced immediately. Other parts may be safe to continue to use, but a monitoring schedule may be adjusted. Alternatively or additionally, one or more inputs or controls relating to a process may be adjusted as part of the corrective action. These and other details about the equipment, sensors, processing of sensor data, and actions taken based on sensor data are described in further detail below. Such corrective actions may be implemented as part of a modified mobile workflow. Such a mobile workflow may include step-by-step instructions/procedures for a field worker to implement and the workflow may be modified in response to a current operating condition for a measurable element, such as a pressure measurement, of an asset, such as a PSA unit. For example, a field worker repairing or working on a piece of equipment as part of a multi-step workflow may receive, at a device, an updated workflow or next step in the workflow based on the current operating condition for the measurable element.

Monitoring the PSA units and the processes using PSA units may include collecting data that may be correlated and used to predict behavior or problems in different PSA units used in the same plant or in other plants and/or processes. Data collected from the various sensors (e.g., measurements such as flow, pressure drop, thermal performance, vessel skin temperature at the top, vibration) may be correlated with external data, such as environmental or weather data. Process changes or operating conditions may be able to be altered to preserve the equipment until the next scheduled maintenance period. Fluids may be monitored for corrosive contaminants and pH may be monitored in order to predict higher than normal corrosion rates within the PSA equipment. At a high level, sensor data collected (e.g., by the data collection platform) and data analysis (e.g., by the data analysis platform) may be used together, for example, for process simulation, equipment simulation, providing or updating a workflow, and/or other tasks. For example, sensor data may be used for process simulation and reconciliation of sensor data. The resulting improved process simulation may provide a stream of physical properties that may be used to calculate heat flow, etc. These calculations may lead to thermal and pressure drop performance prediction calculations for specific equipment, and comparisons of equipment predictions to observations from the operating data (e.g., predicted/expected outlet temperature and pressure vs. measured outlet temperature and pressure). This may enable identification of one or issues that may eventually lead to a potential control changes and/or recommendations, etc.

Sensor data may be collected by a data collection platform 401. The sensors may interface with the data collection platform 401 via wired or wireless transmissions. Sensor data (e.g., temperature, level, flow, density, pH) may be collected continuously or at periodic intervals (e.g., every second, every five seconds, every ten seconds, every minute, every five minutes, every ten minutes, every hour, every two hours, every five hours, every twelve hours, every day, every other day, every week, every other week, every month, every other month, every six months, every year, or another interval). Data may be collected at different locations at different intervals. For example, data at a known hot spot may be collected at a first interval, and data at a spot that is not a known hot spot may be collected at a second interval. The data collection platform 401 may continuously or periodically (e.g., every second, every minute, every hour, every day, once a week, once a month) transmit collected sensor data to a data analysis platform, which may be nearby or remote from the data collection platform.

The computing system environment 400 of FIG. 4A includes logical block diagrams of numerous platforms and devices that are further elaborated upon in FIG. 4B, FIG. 4C, FIG. 4D, and FIG. 4E. FIG. 4B is an illustrative data collection platform 401, such as a production process data device and/or workflow platform described below. FIG. 4C is an illustrative data analysis platform 405, such as a production process data device described below. FIG. 4D is an illustrative control platform 403, such as a workflow platform described below. FIG. 4E is an illustrative remote device 413 and 415, such as a mobile device. These platforms and devices of FIG. 4 include one or more processing units (e.g., processors) to implement the methods and functions of certain aspects of the present disclosure in accordance with the example embodiments. The processors may include general-purpose microprocessors and/or special-purpose processors designed for particular computing system environments or configurations. For example, the processors may execute computer-executable instructions in the form of software and/or firmware stored in the memory of the platform or device. Examples of well-known computing systems, environments, and/or configurations that may be suitable for use with the disclosed embodiments include, but are not limited to, personal computers (PCs), server computers, hand-held or laptop devices, smart phones, multiprocessor systems, microprocessor-based systems, programmable consumer electronics, network PCs, minicomputers, mainframe computers, virtual machines, distributed computing environments that include any of the above systems or devices, and the like.

In addition, the platform and/or devices in FIG. 4 may include one or more memories of a variety of computer-readable media. Computer-readable media may be any available media that may be accessed by the data collection platform, may be non-transitory, and may include volatile and nonvolatile, removable and non-removable media implemented in any method or technology for storage of information such as computer-readable instructions, object code, data structures, database records, program modules, or other data. Examples of computer-readable media may include random access memory (RAM), read only memory (ROM), electronically erasable programmable read only memory (EEPROM), flash memory or other memory technology, compact disk read-only memory (CD-ROM), digital versatile disks (DVD) or other optical disk storage, magnetic cassettes, magnetic tape, magnetic disk storage or other magnetic storage devices, or any other medium that may be used to store the desired information and that may be accessed by the data collection platform. The memories in the platform and/or devices may further store modules that may comprise compiled software code that causes the platform, device, and/or overall system to operate in a technologically improved manner as disclosed herein. For example, the memories may store software used by a computing platform, such as operating system, application programs, and/or associated database. Alternatively or additionally, a module may be implemented in a virtual machine or multiple virtual machines.

Furthermore, the platform and/or devices in FIG. 4 may include one or more communication interfaces including, but not limited to, a microphone 443, keypad, touch screen, and/or stylus through which a user of a computer (e.g., a remote device) may provide input, and may also include a speaker for providing audio output and a video display device for providing textual, audiovisual and/or graphical output. The communication interfaces may include a network controller for electronically communicating (e.g., wirelessly or wired) over a public network or private network with one or more other components on the network. The network controller may include electronic hardware for communicating over network protocols, including TCP/IP, UDP, Ethernet, and other protocols.

In some examples, one or more sensor devices in FIG. 4A may be enhanced by incorporating functionality that may otherwise be found in a data collection platform 401. These enhanced sensor system may provide further filtering of the measurements and readings collected from their sensor devices. For example, with some of the enhanced sensor systems in the operating environment 400 illustrated in FIG. 4A, an increased amount of processing may occur at the sensor so as to reduce the amount of data needing to be transferred over a private network 407 in real-time to a computing platform. The enhanced sensor system may filter at the sensor itself the measured/collected/captured data and only particular, filtered data may be transmitted to the data collection platform 401 for storage and/or analysis.

Referring to FIG. 4B, in one example, a data collection platform 401 may comprise a processor 461, one or more memories 462, and communication interfaces 467. The memory 462 may comprise a database 463 for storing data records of various values collected from one or more sources. In addition, a data collection module 464 may be stored in the memory and assist the processor in the data collection platform in communicating with, via the communications interface, one or more sensor, measurement, and data capture systems, and processing the data received from these sources. In some embodiments, the data collection module 464 may comprise computer-executable instructions that, when executed by the processor, cause the data collection platform 401 to perform one or more of the steps disclosed herein. In other embodiments, the data collection module 464 may be a hybrid of software-based and/or hardware-based instructions to perform one or more of the steps disclosed herein. In some examples, the data collection module 464 may assist an enhanced sensor system with further filtering the measurements and readings collected from the sensor devices. In some examples, the data collection module 464 may receive some or all data from a plant or piece of equipment, and/or may provide that data to one or more other modules or servers.

Data collection platform 401 may include or be in communication with one or more data historians 465. The data historian 465 may be implemented as one or more software modules, one or more virtual machines, or one or more hardware elements (e.g., servers). The data historian 465 may collect data at regular intervals (e.g., every minute, every two minutes, every ten minutes, every thirty minutes).

The data historian 465 may include or be in communication with a process scout 466. The process scout 466 may be implemented as one or more software modules, one or more virtual machines, or one or more hardware elements (e.g., servers). The process scout 466 may work with or in place of the data collection module 401 and/or the data historian 465 to handle one or more aspects of data replication.

Although the elements of FIG. 4B are illustrated as logical block diagrams, the disclosure is not so limited. In particular, one or more of the logical boxes in FIG. 4B may be combined into a single logical box or the functionality performed by a single logical box may be divided across multiple existing or new logical boxes. Moreover, some logical boxes that are visually presented as being inside of another logical box may be moved such that they are partially or completely residing outside of that logical box. For example, while the database 463 in FIG. 4B is illustrated as being stored inside one or more memories 462 in the data collection platform 401, FIG. 4B contemplates that the database 463 may be stored in a standalone data store communicatively coupled to the data collection module 401 and processor 461 of the data collection platform 401 via the communications interface(s) 467 of the data collection platform 401.

In addition, the data collection module 464 may assist the processor 462 in the data collection platform 401 in communicating with, via the communications interface 467, and processing data received from other sources, such as data feeds from third-party servers and manual entry at the field site from a dashboard graphical user interface. For example, a third-party server may provide contemporaneous weather data to the data collection module. Some elements of chemical and petrochemical/refinery plants may be exposed to the outside and thus may be exposed to various environmental stresses. Such stresses may be weather related such as temperature extremes (hot and cold), high wind conditions, and precipitation conditions such as snow, ice, and rain. Other environmental conditions may be pollution particulates such as dust and pollen, or salt if located near an ocean, for example. Such stresses may affect the performance and lifetime of equipment in the plants. Different locations may have different environmental stresses. For example, a refinery in Texas will have different stresses than a chemical plant in Montana. In another example, data manually entered from a dashboard 423 and 425 graphical user interface (or other means) may be collected and saved into memory 462 by the data collection module 401. Production rates may be entered and saved in memory. Tracking production rates may indicate issues with flows. For example, as fouling occurs, the production rate may fall if a specific outlet temperature may no longer be achieved at the targeted capacity and capacity has to be reduced to maintain the targeted outlet temperature.

Referring to FIG. 4C, in one example, a data analysis platform 405 may comprise a processor 471, one or more memories 472, and communication interfaces 479. The memory 472 may comprise a database for storing data records of various values collected from one or more sources. Alternatively, the database may be the same database as that depicted in FIG. 4B and the data analysis platform 405 may communicatively couple with the database via the communication interface 479 of the data analysis platform 405. At least one advantage of sharing a database between the two platforms is the reduced memory requirements due to not duplicating the same or similar data.

In addition, the data analysis platform 405 may include a loop scout 473. In some embodiments, the loop scout 473 may comprise computer-executable instructions that, when executed by the processor 471, cause the data analysis platform 405 to perform one or more of the steps disclosed herein. In other embodiments, the loop scout 473 may be a virtual machine. In some embodiments, the loop scout 473 may be a hybrid of software-based and/or hardware-based instructions to perform one or more of the steps disclosed herein.

Further, the data analysis platform 405 may include a data service 474. In some embodiments, the data service 474 may comprise computer-executable instructions that, when executed by the processor 471, cause the data analysis platform 405 to perform one or more of the steps disclosed herein. In other embodiments, the data service 474 may be a virtual machine. In some embodiments, the data service 474 may be a hybrid of software-based and/or hardware-based instructions to perform one or more of the steps disclosed herein.

Also, the data analysis platform 405 may include a data historian 475. In some embodiments, the data historian 475 may comprise computer-executable instructions that, when executed by the processor 471, cause the data analysis platform 405 to perform one or more of the steps disclosed herein. In other embodiments, the data historian 475 may be a virtual machine. In some embodiments, the data historian 475 may be a hybrid of software-based and/or hardware-based instructions to perform one or more of the steps disclosed herein. The data historian 475 may collect data at regular intervals (e.g., every minute, every two minutes, every ten minutes, every thirty minutes).

Additionally, the data analysis platform 405 may include a data lake 476. In some embodiments, the data lake 476 may comprise computer-executable instructions that, when executed by the processor 471, cause the data analysis platform 405 to perform one or more of the steps disclosed herein. In other embodiments, the data lake 476 may be a virtual machine. In some embodiments, the data lake 476 may be a hybrid of software-based and/or hardware-based instructions to perform one or more of the steps disclosed herein. The data lake 476 may perform relational data storage. The data lake 476 may provide data in a format that may be useful for processing data and/or performing data analytics.

Moreover, the data analysis platform 405 may include a calculations service 477. In some embodiments, the calculations service 477 may comprise computer-executable instructions that, when executed by the processor 471, cause the data analysis platform 405 to perform one or more of the steps disclosed herein. In other embodiments, the calculations service 477 may be a virtual machine. In some embodiments, the calculations service 477 may be a hybrid of software-based and/or hardware-based instructions to perform one or more of the steps disclosed herein. The calculations service 477 may collect data, perform calculations, and/or provide key performance indicators. The calculations service may implement, for example, process dynamic modeling software or tools (e.g., UniSim).

Furthermore, the data analysis platform 405 may include a utility service 478. In some embodiments, the utility service 478 may comprise computer-executable instructions that, when executed by the processor 471, cause the data analysis platform 405 to perform one or more of the steps disclosed herein. In other embodiments, the utility service 478 may be a virtual machine. In some embodiments, the utility service 478 may be a hybrid of software-based and/or hardware-based instructions to perform one or more of the steps disclosed herein. The utility service 478 may take information from the calculations service 477 and put the information into the data lake 476. The utility service 478 may provide data aggregation service, such as taking all data for a particular range, normalizing the data (e.g., determining an average), and combining the normalized data into a file to send to another system or module.

One or more components of the data analysis platform 405 may assist the processor 471 in the data analysis platform 405 in processing and analyzing the data values stored in the database. In some embodiments, the data analysis platform 405 may perform statistical analysis, predictive analytics, and/or machine learning on the data values in the database to generate predictions and models. For example, the data analysis platform 405 may analyze sensor data to detect new hot spots and/or to monitor existing hot spots (e.g., to determine if an existing hot spot is growing, maintaining the same size, or shrinking) in the equipment of a plant. The data analysis platform 405 may compare temperature data from different dates to determine if changes are occurring. Such comparisons may be made on a monthly, weekly, daily, hourly, real-time, or some other basis.

Referring to FIG. 4C, the data analysis platform 405 may generate recommendations for adjusting one or more parameters for the operation of the plant environment depicted in FIG. 4A. In some embodiments, the data analysis platform 405 may, based on the recommendations, generate command codes that may be transmitted, via the communications interface 479, to cause adjustments or halting/starting of one or more operations in the plant environment. The command codes may be transmitted to a control platform 403 for processing and/or execution. In an alternative embodiment, the command codes may be directly communicated, either wirelessly or in a wired fashion, to physical components at the plant, where the physical components comprise an interface to receive the commands and execute them.

Although the elements of FIG. 4C are illustrated as logical block diagrams, the disclosure is not so limited. In particular, one or more of the logical boxes in FIG. 4C may be combined into a single logical box or the functionality performed by a single logical box may be divided across multiple existing or new logical boxes. Moreover, some logical boxes that are visually presented as being inside of another logical box may be moved such that they are partially or completely residing outside of that logical box. For example, while the database is visually depicted in FIG. 4C as being stored inside one or more memories in the data analysis platform, FIG. 4C contemplates that the database may be stored in a standalone data store communicatively coupled to the processor of the data analysis platform via the communications interface of the data analysis platform. Furthermore, the databases from multiple plant locations may be shared and holistically analyzed to identify one or more trends and/or patterns in the operation and behavior of the plant and/or plant equipment. In such a crowdsourcing-type example, a distributed database arrangement may be provided where a logical database may simply serve as an interface through which multiple, separate databases may be accessed. As such, a computer with predictive analytic capabilities may access the logical database to analyze, recommend, and/or predict the behavior of one or more aspects of plants and/or equipment. In another example, the data values from a database from each plant may be combined and/or collated into a single database where predictive analytic engines may perform calculations and prediction models.

Referring to FIG. 4D, in one example, a control platform 403 may comprise a processor 481, one or more memories 482, and communication interfaces 486. The memory 482 may comprise a database 483 for storing data records of various values transmitted from a user interface, computing device, or other platform. The values may comprise parameter values for particular equipment 427 and 429 at the plant. For example, some illustrative equipment at the plant that may be configured and/or controlled by the control platform include, but is not limited to, a feed switcher, sprayer, one or more valves 429, one or more pumps 427, one or more gates, and/or one or more drains. In addition, a control module 484 may be stored in the memory 482 and assist the processor 481 in the control platform 403 in receiving, storing, and transmitting the data values stored in the database. In some embodiments, the control module 484 may comprise computer-executable instructions that, when executed by the processor 471, cause the control platform 403 to perform one or more of the steps disclosed herein. In other embodiments, the control module 403 may be a hybrid of software-based and/or hardware-based instructions to perform one or more of the steps disclosed herein.

The control platform 403 may include a local analytics module 485. In some embodiments, a control program (e.g., that runs PSA processes) may include an embedded analytics module. Calculating analytics locally (e.g., rather than remotely on the cloud) may provide some benefits, such as increased response time for providing real-time information to local plant systems. For example, if a thousand valves that open and close 10 times a second are each providing operating information to the local control platform, the sheer volume of data may introduce a delay in calculating short-term maintenance-required calculations, analytics, or alerts if there is not sufficient bandwidth between the plant and the remote cloud processing system. Thus, a subset of the analytics data (e.g., analytics data relevant to realtime operating information, equipment for which a delayed failure alert may result in a catastrophic failure, or the like) may be processed and provided locally, while other data (e.g., analytics data related to long-time trends, historical analytics data, or the like) may be sent to a cloud platform for processing. In some embodiments, all the data is sent to the cloud, including the data that is processed locally. The data processed locally may be used for providing realtime information, such as alerts, control system changes, and/or updating workflows, and sent to the cloud for logging, storage, long-term or historical trends analysis, or the like. The local version of the data may be discarded after a certain time period. Local and/or cloud data may be combined on a dashboard 423 and 425, or alternatively may be provided on separate dashboards 423 and 425.

In a plant environment such as illustrated in FIG. 4A, if sensor data is outside of a safe range, this may be cause for immediate danger. As such, there may be a real-time component to the system such that the system processes and responds in a timely manner. Although in some embodiments, data may be collected and leisurely analyzed over a lengthy period of months, numerous embodiments contemplate a real-time or near real-time responsiveness in analyzing and generating alerts, such as those generated or received by the alert module in FIG. 4E.

Referring to FIG. 4E, in one example, a remote device 413 may comprise a processor 491, one or more memories 492, and communication interfaces 497. The memory 492 may comprise a database 493 for storing data records of various values entered by a user or received through the communications interface 497. In addition, an alert module 494, command module 495, and/or dashboard module 496 may be stored in the memory 492 and assist the processor 491 in the remote device 413 in processing and analyzing the data values stored in the database 493. In some embodiments, the aforementioned modules may comprise computer-executable instructions that, when executed by the processor 491, cause the remote device 413 to perform one or more of the steps disclosed herein. In other embodiments, the aforementioned modules may be a hybrid of software-based and/or hardware-based instructions to perform one or more of the steps disclosed herein. In some embodiments, the aforementioned modules may generate alerts based on values received through the communications interface 497. The values may indicate a dangerous condition or even merely a warning condition due to odd sensor readings. The command module 495 in the remote device 413 may generate a command that when transmitted through the communications interface 497 to the platforms at the plant, causes adjusting of one or more parameter operations of the plant environment depicted in FIG. 4A. In some embodiments, the dashboard module 496 may display a graphical user interface to a user of the remote device 413 to enable the user to enter desired parameters and/or commands. These parameters/commands may be transmitted to the command module to generate the appropriate resulting command codes that may be then transmitted, via the communications interface 496, to cause adjustments or halting/starting of one or more operations in the plant environment (e.g., updating one or more workflows). The command codes may be transmitted to a control platform 403 for processing and/or execution. In an alternative embodiment, the command codes may be directly communicated, either wirelessly or in a wired fashion, to physical components at the plant such that the physical components comprise an interface to receive the commands and execute them.

Although FIG. 4E is not so limited, in some embodiments the remote device 413 may comprise a desktop computer, a smartphone, a wireless device, a tablet computer, a laptop computer, and/or the like. The remote device may be physically located locally or remotely, and may be connected by one of communications links to the public network 409 that is linked via a communications link to the private network 407. The network used to connect the remote device 413 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links may be any communications links suitable for communicating between workstations and server, such as network links, dial-up links, wireless links, hard-wired links, as well as network types developed in the future, and the like. Various well-known protocols such as transmission control protocol/Internet protocol (TCP/IP), Ethernet, file transfer protocol (FTP), hypertext transfer protocol (HTTP) and the like may be used, and the system may be operated in a client-server configuration to permit a user to retrieve web pages from a web-based server. Any of various conventional web browsers may be used to display and manipulate data on web pages.

Although the elements of FIG. 4E are illustrated as logical block diagrams, the disclosure is not so limited. In particular, one or more of the logical boxes in FIG. 4E may be combined into a single logical box or the functionality performed by a single logical box may be divided across multiple existing or new logical boxes. Moreover, some logical boxes that are visually presented as being inside of another logical box may be moved such that they are partially or completely residing outside of that logical box. For example, while the database is visually depicted in FIG. 4E as being stored inside one or more memories in the remote device, FIG. 4E contemplates that the database 493 may be stored in a standalone data store communicatively coupled, via the communications interface 496, to the modules stored at the remote device 413 and processor 491 of the remote device 413.

Referring to FIG. 4, in some examples, the performance of operation in a plant may be improved by using a cloud computing infrastructure and associated methods. The methods may include, in some examples, obtaining plant operation information from the plant and/or generating a plant process model using the plant operation information. The method may include receiving plant operation information over the Internet, or other computer network (including those described herein) and automatically generating a plant process model using the plant operation information. These plant process models may be configured and used to monitor, predict, and/or optimize performance of individual process units, operating blocks and/or complete processing systems. Routine and frequent analysis of predicted versus actual performance may further allow early identification of operational discrepancies which may be acted upon to optimize impact, including financial or other impact.

At the stack level, the cloud-computing infrastructure may provide a secure, scalable infrastructure for collecting, aggregating and storing data, allowing connected “things” to communicate, making an offering/SaaS solution available, IaaS/PaaS, and/or data lakes. Different devices, systems, and/or platforms may be connected via the cloud or direct, remote connection (e.g., Lyric Thermostat, SaaS). Furthermore, the disclosure may include infrastructure enabling connected services (e.g., Sentience). The aforementioned cloud computing infrastructure may use a data collection platform (such as process scout) associated with a plant to capture data, e.g., sensor measurements, which may be automatically sent to the cloud infrastructure, which may be remotely located, where it is reviewed to, for example, eliminate errors and biases, and used to calculate and report performance results. The data collection platform may include an optimization unit that acquires data from a customer site, other site, and/or plant (e.g., sensors and other data collectors at a plant) on a recurring basis. For cleansing, the data may be analyzed for completeness and corrected for gross errors by the optimization unit. The data may also be corrected for measurement issues (e.g., an accuracy problem for establishing a simulation steady state) and overall mass balance closure to generate a duplicate set of reconciled plant data. The corrected data may be used as an input to a simulation process, in which the process model is tuned to ensure that the simulation process matches the reconciled plant data. An output of the reconciled plant data may be used to generate predicted data using a collection of virtual process model objects as a unit of process design.

The performance of the plant and/or individual process units of the plant is/are compared to the performance predicted by one or more process models to identify any operating differences or gaps. Furthermore, the process models and collected data (e.g., plant operation information) may be used to run optimization routines that converge on an optimal plant operation for a given values of, e.g., feed, products, and/or prices. A routine may be understood to refer to a sequence of computer programs or instructions for performing a particular task.

The data analysis platform may comprise an analysis unit that determines operating status, based on at least one of a kinetic model, a parametric model, an analytical tool, and a related knowledge and best practice standard. The analysis unit may receive historical and/or current performance data from one or a plurality of plants to proactively predict future actions to be performed. To predict various limits of a particular process and stay within the acceptable range of limits, the analysis unit may determine target operational parameters of a final product based on actual current and/or historical operational parameters. This evaluation by the analysis unit may be used to proactively predict future actions to be performed. In another example, the analysis unit may establish a boundary or threshold of an operating parameter of the plant based on at least one of an existing limit and an operation condition. In yet another example, the analysis unit may establish a relationship between at least two operational parameters related to a specific process for the operation of the plant. Finally in yet another example, one or more of the aforementioned examples may be performed with or without a combination of the other examples.

The plant process model may predict plant performance that is expected based upon plant operation information. The plant process model results may be used to monitor the health of the plant and to determine whether any upset or poor measurement occurred. The plant process model may be generated by an iterative process that models at various plant constraints to determine the desired plant process model.

Further, the analytics unit may be partially or fully automated. In one embodiment, the system is performed by a computer system, such as a third-party computer system, remote from or local to the plant and/or the plant planning center. The system may receive signals and parameters via the communication network, and displays in real time (or near real time) related performance information on an interactive display device accessible to an operator or user. The platform allows all users to work with the same information, thereby creating a collaborative environment for sharing best practices or for troubleshooting. The method further provides more accurate prediction and optimization results due to fully configured models. Routine automated evaluation of plant planning and operation models allows timely plant model tuning to reduce or eliminate gaps between plant models and the actual plant performance. Implementing the aforementioned methods using the platform also allows for monitoring and updating multiple pieces of equipment, thereby better enabling facility planners to propose realistic optimal targets.

The disclosure integrates information from a system managing production process with a mobile workflow platform. The integration allows production process information to be included in field worker mobile workflows so that checks against process information may be included in the logic of the workflow, including alternate workflows to be performed when process conditions indicate. For example, field observations of process measurements may indicate that immediate corrective action should be performed in order to protect production assets from damage or failure. In order to do this, a field worker needs to know what the normal operating limits for the asset are and what to do if the limits are exceeded. Field workers typically do not have access to asset operating limits (particularly not in the field), nor knowledge of what to do if they are exceeded. Another example concerns field worker safety when performing field tasks, such as a line-breaking activity on a process line. In this case, it may be that work should only proceed as long as the pressure in the process line is below some safe threshold. This requires a check of the current pressure in the line. Typically, the current pressure is available to a console operator in the control room and the field worker will typically contact the console operator by radio to query the current pressure, which wastes time and distracts the console operator from their activities. In addition, due to the loud noise of a plant, the console operator or field worker may not hear or may incorrectly hear the request or returned message by radio. Also, the current pressure may change quickly, meaning that even if the field worker obtains a pressure from the console operator, the current pressure may change by the time the field worker acts on that information.

FIG. 5 depicts an illustrative computing environment for managing the operation of one or more pieces of equipment in a plant in accordance with one or more example embodiments. In this case, local or remote data is published into a mobile workflow platform, which may be cloud-based, from where it can be combined with workflows that are authored elsewhere, but reference the published data. Current published data is provided directly to a client device used by the field worker on which the step-by-step workflow logic is executed. An alternative to the example of FIG. 5 would have the current condition data routed to the mobile device via the mobile workflow platform. FIG. 5 is but one illustrative computing environment and one or more components of the same may be duplicated, combined and/or removed while other similar components may be added. FIG. 5 shows a client device 501. Client device 501 may be a mobile computing device, such as a mobile phone and/or tablet computing device. Client device 501 may be a mobile wireless electronic device utilized by a field worker in a plant for implementing one or more tasks associated with one or more plant assets, such as a PSA unit, a pipeline, and/or a feed valve. Client device 501 is shown in communication with a workflow platform 502. Workflow platform 502 may include one or more mobile workflows for implementation by the client device 501. A mobile workflow may represent a scheduled series of actions the field worker of the client device 502 may utilize to complete the task associated with the plant asset. Workflow platform 502 also may include asset operation data. Asset operation data may represent one or more operating limits for a measurable element (temperature, pressure, level, flow, density, pH) of the asset, e.g., acceptable upper and/or lower bound values for a pressure level in a particular PSA unit, a threshold feed pressure value, and/or an acceptable upper and lower temperature value for a particular pipeline. The asset operation data from backend connectors 505 may be combined with asset operation data received from a production process data device 504 via a connector 503. Either or both of the asset operation data from backend connectors 505 and from the production process data device 504 may be received periodically, since such data may be relatively static and not change very often. In example systems, asset operation data may be received once a week or once a month. Asset operation data may be received less frequently that current condition data. In some examples, asset operation data may be received periodically by the client device 501 executing the workflow. In still other examples, asset operation data may just be received along with the mobile workflow and not subsequently updated.

A production process data device 504 may be part of a system that manages production process information as part of a distributed control system. Production process information may include asset operation data and current condition data. Asset operation data may represent one or more general operating limits for a measurable element of an asset. The asset operation data may be general asset operation data, as opposed to asset operation data from one or more backend systems. Current condition data may represent a current operating condition for one or more measurable elements of the asset. For example, the current operating condition for a measureable element of the asset may be the current reading of a pressure on a particular gas pipeline, the current reading of a temperature on the particular gas pipeline, or a current reading of the flow within the particular gas pipeline.

Asset operation data and current condition data from the production process data device 504 may be sent 506 to a connector 503. Connector 503 may be a translation tool connected to the workflow platform 502 to speed up system integration. Connector 503 may allow any back-end system to connect to the workflow platform and to expose data and business processes. As shown, connector 503 may send 507 the asset operation data from the production process data device 504 to the workflow platform 502. This sent asset operation data 507 may then be combined with the asset operation data received by the workflow platform 502 from backend connectors 505. Current condition data may be sent 508 from the connector 503 to the client device 501 upon receipt of a request for such data.

The mobile workflow(s) and the combined asset operation data may be sent 510 to the client device 501 via the workflow platform 502. Workflow platform 502 may receive 509 the mobile workflow(s) and/or the asset operation data from one or more backend systems through one or more backend connectors 505. Backend systems and backend connectors 505 may be any of a number of systems for creating and sending workflow(s) and asset operation data for one or more assets under different environmental conditions, operational conditions, and/or locations. Client device 501 may implement the one or more workflows and sent results of the workflows 511 to the workflow platform 502 which may then send 512 the workflow results back to the backend connectors 505.

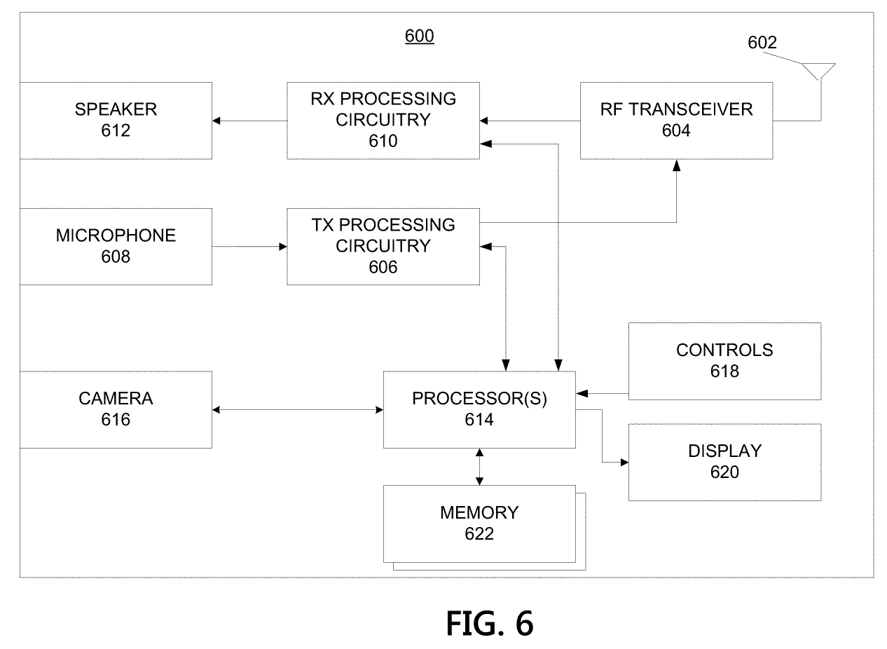

FIG. 6 depicts an illustrative example computing device supporting augmented field workflows to an industrial process, control and automation system, or other systems according to this disclosure. In particular, FIG. 6 illustrates an example mobile device 600. The mobile device 600 may be used to implement one or more mobile workflows by a field workers. A mobile workflow may represent a scheduled series of actions a field worker may utilize to complete a task associated with an asset. For example, a task may be to perform a maintenance operation on a particular asset, such as a PSA unit or a particular gas pipeline. Mobile device 600 may be used to support the generation or presentation of step-by-step actions (such as by providing operational, diagnostic, or other data to the mobile device 600) for performing the required maintenance. For ease of explanation, the mobile device 600 may be used in the system 100 of FIG. 1 and FIG. 5, although the mobile device 600 may be used in any other suitable system (whether or not related to industrial process control and automation).

As shown in FIG. 6, the mobile device 600 includes an antenna 602, a radio frequency (RF) transceiver 604, transmit (TX) processing circuitry 606, a microphone 608, receive (RX) processing circuitry 610, and a speaker 612. The mobile device 600 also may include a one or more processors 614, a camera 616, one or more physical controls 618, a display 620, and one or more memories 622.

The RF transceiver 604 receives, from the antenna 602, an incoming RF signal, such as a cellular, WiFi, and/or BLUETOOTH signal. The RF transceiver 604 down-converts the incoming RF signal to generate an intermediate frequency (IF) or baseband signal. The IF or baseband signal is sent to the RX processing circuitry 610, which generates a processed baseband signal by filtering, decoding, and/or digitizing the baseband or IF signal. The RX processing circuitry 610 may transmit the processed baseband signal to the speaker 612 or to the processor 614 for further processing.

The TX processing circuitry 606 receives analog or digital data from the microphone 608 or other outgoing baseband data from the processor 614. The TX processing circuitry 606 encodes, multiplexes, and/or digitizes the outgoing baseband data to generate a processed baseband or IF signal. The RF transceiver 604 receives the outgoing processed baseband or IF signal from the TX processing circuitry 606 and up-converts the baseband or IF signal to an RF signal that is transmitted via the antenna 602.

The processor 614 may include one or more processors or other processing devices and execute an operating system, applications, or other logic stored in the memory 622 in order to control the overall operation of the mobile device 600. For example, the processor 614 may control the transmission and reception of signals by the RF transceiver 604, the RX processing circuitry 610, and the TX processing circuitry 606 in accordance with well-known principles. In some embodiments, the processor 614 includes at least one microprocessor or microcontroller, although other types of processing devices may also be used.

The processor 614 is also capable of executing other processes and applications resident in the memory 622. For example, processor 614 may receive a mobile workflow via the RF transceiver 604 and store the mobile workflow in memory 622. The processor 614 may move data into or out of the memory 622 as required by an executing application, e.g., a mobile workflow. The processor 614 is also coupled to the camera 616, which provides data to the processor 614 for the generation of digital images or video streams. The images or video streams may be presented to a user via the display 620.

The processor 614 is also coupled to the physical controls 618 and the display 620. A user of the mobile device 600 may use the physical controls 618 to invoke certain functions, such as powering on or powering off the device 600, controlling a volume of the device 600, and inputting measured values, such as pressure, temperature, or flow rate. The display 620 may be a liquid crystal display (LCD), light emitting diode (LED) display, or other display capable of rendering text and graphics. If the display 620 denotes a touchscreen capable of receiving input, fewer or no physical controls 618 may be needed.

The memory 622 is coupled to the processor 614. Part of the memory 622 may include a random access memory (RAM), and another part of the memory 622 may include a Flash memory or other read-only memory (ROM). Each memory 622 includes any suitable structure for storing and facilitating retrieval of information.

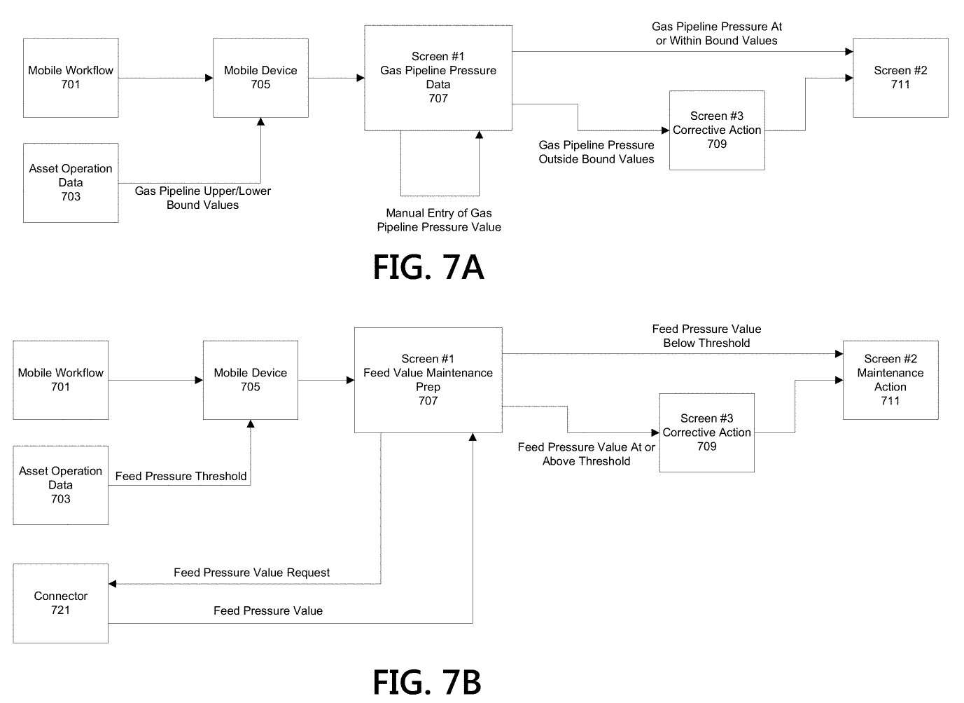

FIGS. 7A-7B depict illustrative data flows of one or more steps that one or more devices may perform in controlling one or more aspects of a plant operation in accordance with one or more example embodiments described herein. As shown in FIG. 7A, a mobile workflow 701 and asset operation data 703 may be sent to a mobile device 705. In this example, asset operation data 703 may be acceptable upper- and/or lower-bound values for pressure in a particular gas pipeline. As part of the mobile workflow 701 implemented on the mobile device 705, a screen #1 may be displayed 707 as part of the step-by-step instructions that may be displayed (e.g., to a field worker) when implementing the mobile workflow. In this example, the screen #1 may be a screen describing an action for the field worker to manually enter a pressure value for the particular gas pipeline, the particular asset. Upon entry of the pressure value by the field worker, a determination is made by the mobile device 705 in accordance with the mobile workflow as to whether a difference between the pressure value for the particular gas pipeline and the acceptable upper- and/or lower-bound values meets the acceptable upper- and/or lower-bound values, e.g., whether the manually entered pressure value is at or within the upper- and lower-bound values. If the gas pressure value is at or within the bound values, a screen #2 may be displayed 711 for a next action in the mobile workflow. Alternatively, if the gas pressure value is outside the bound values, the mobile workflow may be modified and a new corrective action screen #3 may be displayed 709 for a corrective action to be taken by the field worker. For example, if the pressure value is too high, the corrective action may be to lower the pressure by adjusting one or more valves. The modified mobile workflow may include step-by-step instructions for how to handle the needed corrective action. The step-by-step instructions may be outside of the actions in the original mobile workflow 701. Other examples include increasing or decreasing a flow rate, opening, closing, or adjusting a valve, starting, stopping, extending, or shortening a process, opening or closing a gate, opening or closing a drain, or the like.

As shown in FIG. 7B, asset operation data 703 may be acceptable threshold for pressure in a particular feed valve. As part of the mobile workflow 701 implemented on the mobile device 705, a screen #1 may be displayed 707 as part of the step-by-step instructions a field worker may see when implementing the mobile workflow. In this example, the screen #1 may be information detailing an action for the field worker to implement a feed valve maintenance operation. In this example, the mobile device 705 may request current asset condition data from a connector 721. The current asset may be a particular feed valve and the current asset condition data may be a feed pressure for the valve. Upon receipt of the feed pressure value from the connector 721, a determination is made by the mobile device 705 in accordance with the mobile workflow as to whether a difference between the received feed pressure value and the acceptable threshold meets the acceptable threshold, e.g., whether the feed pressure value is below the threshold. If the gas pressure value is below the threshold, a screen #2 may be displayed 711 for a next action in the mobile workflow. Alternatively, if the gas pressure value is at or above the threshold, the mobile workflow may be modified and a new corrective action screen #3 may be displayed 709 with information on a corrective action to be taken by the field worker. For example, if the feed pressure value is too high, the corrective action may be to lower the pressure by adjusting the feed valve. The modified mobile workflow may include step-by-step instructions for how to handle the needed corrective action. The step-by-step instructions may be outside of the actions in the original mobile workflow 701. Other examples include increasing or decreasing a flow rate, opening or closing a valve, starting, stopping, extending, or shortening a process, or the like.

Aspects of the present disclosure are directed to monitoring PSA unit processes for potential and existing issues, providing alerts, and/or adjusting operating conditions to optimize PSA unit life. There are many process performance indicators that may be monitored including, but not limited to, flow rates, chemical analyzers, temperature, and/or pressure. In addition, valve operation may be monitored, including opening speed, closing speed, and performance.

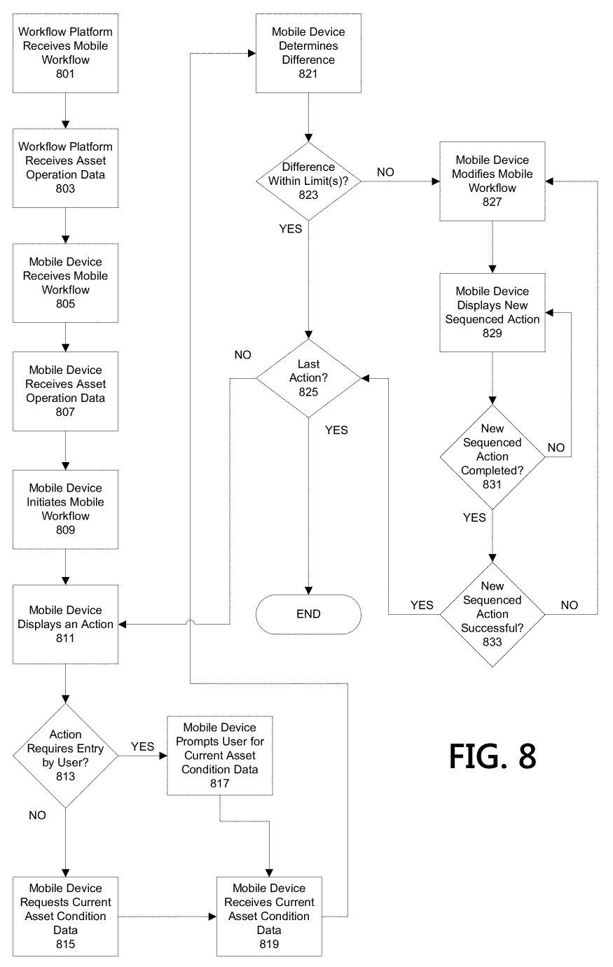

FIG. 8 depicts an illustrative flow diagram of one or more steps that one or more devices may perform in controlling one or more aspects of a plant operation in accordance with one or more example embodiments. In step 801, a workflow platform may receive a mobile workflow. As noted herein, the mobile workflow may be received via a backend connector 505. In step 803, the workflow platform may receive asset operation data representing one or more operating limits for a measurable element of the asset. In step 805 and 807, the workflow platform sends the mobile workflow and the asset operation data to a mobile device. Such a mobile device may be a tablet, mobile phone, pager, and/or other wireless computing device of a field worker. One or more of the steps in FIG. 8 may be combined into a single operation. For example, steps 85 and 807 may be combined as a single step where the workflow platform sends the mobile workflow and the asset operation data together to a mobile device.

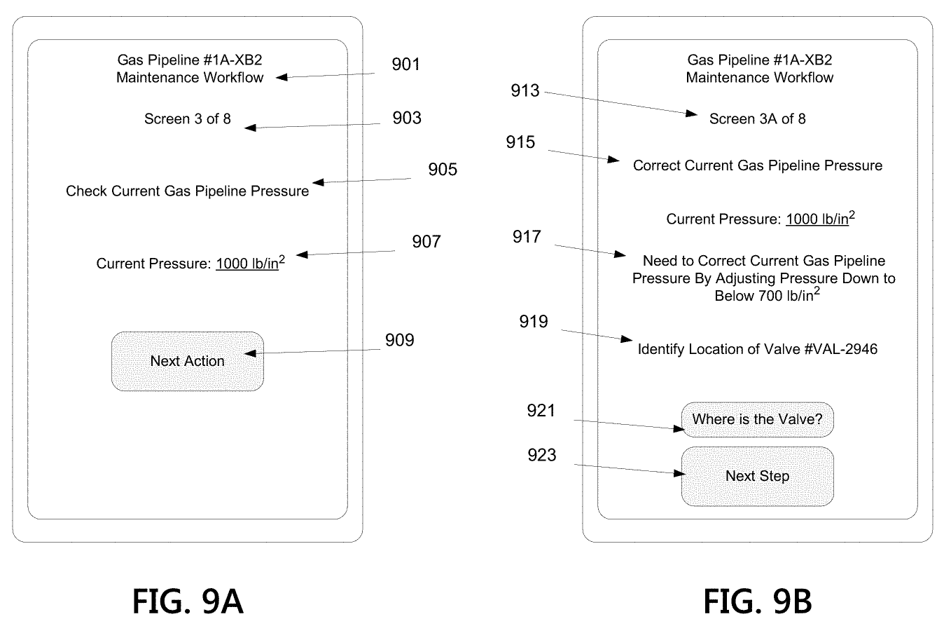

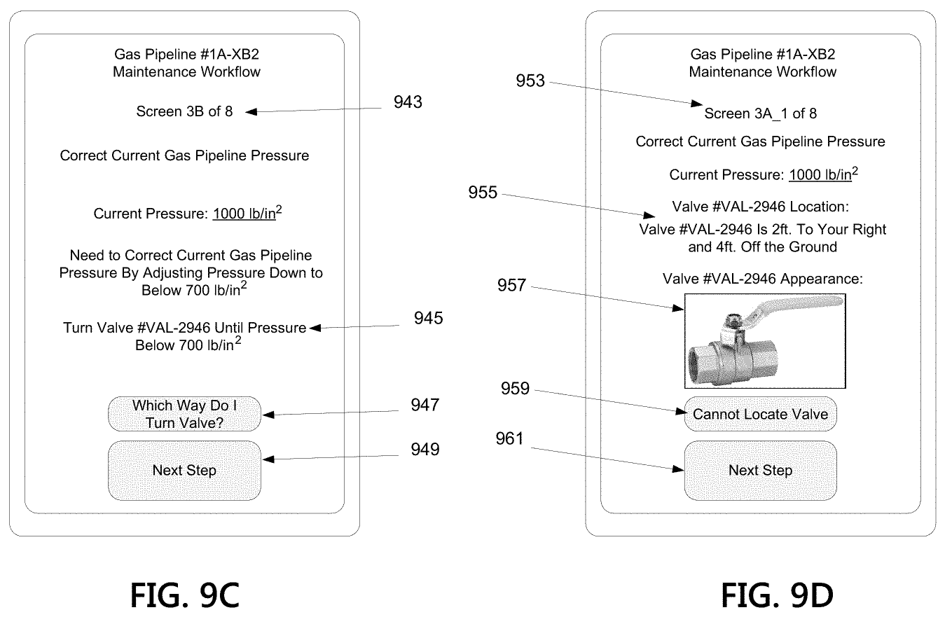

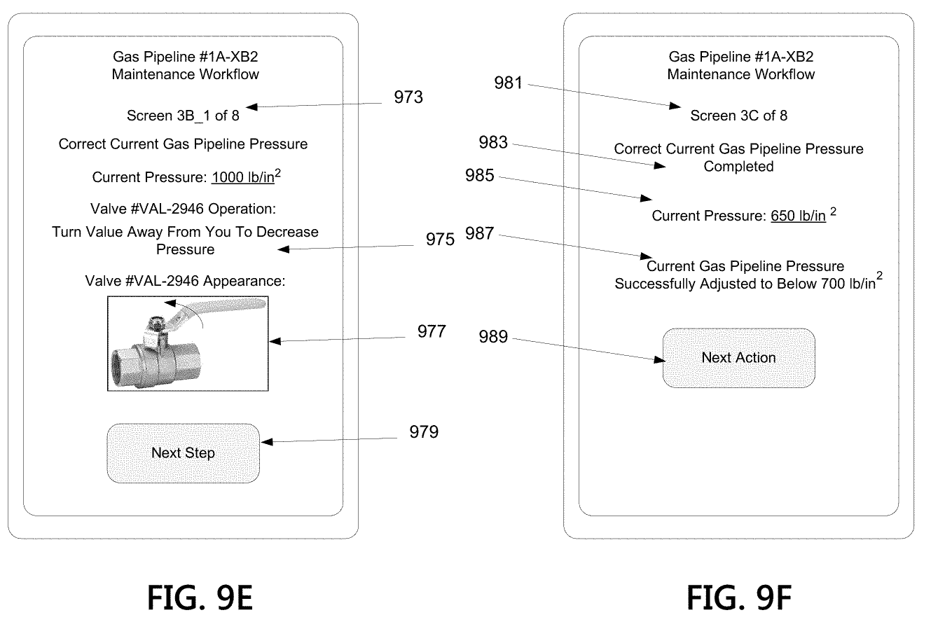

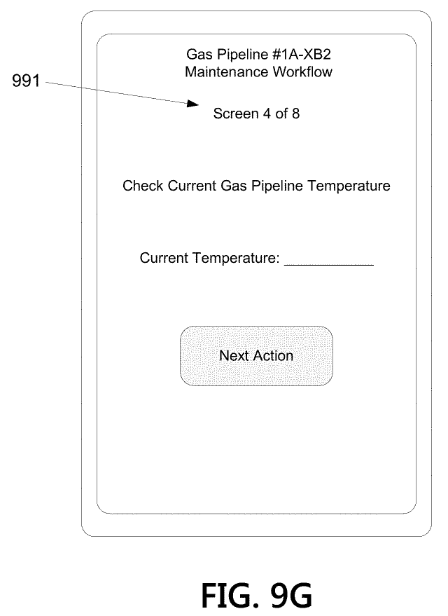

Proceeding to step 809, the mobile device initiates the mobile workflow. Initiation of the mobile workflow may include, as shown in step 811, the mobile device causing display of a first action of the scheduled series of actions in the mobile workflow. In one example, the first action may be an indication that a pressure reading needs to be received. An illustrative example of such a screen may be the displayed screen shown in FIG. 9A. Proceeding to step 813, a determination may be made as to whether the first action requires entry by a user, such as manual entry of the pressure value. If user entry is not required, the mobile device may send a request for the current asset condition data (current pressure) in step 815, such as to connector 721. If the determination in step 813 is that entry by a user is required, the process moves to step 817, where the mobile device prompts the user for entry of the current asset condition data.

Whether from step 815 or step 817, the process moves to step 819, where the mobile device receives the current asset condition data. In the case of step 815, the current asset condition data may be from connector 721 without requiring a field worker to review or perform any reading. In the case of step 817, the current asset condition data may be received by a field worker manually entering in a measured value reading. Proceeding to step 821, the mobile device determines a difference between the current operating condition (current pressure value) for the measurable element (pressure) of the asset (particular gas pipeline) and the one or more operating limits (upper and/or lower bound values) for the measurable element (pressure) of the asset (particular gas pipeline). In step 823, a determination is made as to whether the difference is an acceptable difference. If so, such as the case in which the current operating condition (pressure) within the gas pipeline is within acceptable bounds, the process moves to step 825, where a determination is made as to whether the completed action is a last action 825. If the last action, the process ends; else the process returns to step 811 for a next action.

If the determination in step 823 is that the difference is not an acceptable difference, the process moves to step 827 where the mobile device modifies the mobile workflow. The modification may include changing the scheduled series of actions to include one or more corrective actions the field worker should use to complete the task associated with the asset. In step 829, the mobile device may cause display of a new sequenced action. The new sequenced action may be a corrective action including one or more adjustments to the measurable element of the asset that the field worker needs to make. Proceeding to step 831, a determination may be made as to whether the new sequenced action has been completed (e.g., receive input from the field worker confirming the new sequenced action has been completed, or receive updated control status information indicating a change in the equipment resulting from the sequenced action being completed). If not, the process returns to step 829. If the new sequenced action has been completed, the process moves to step 833, where a determination is made as to whether the new sequenced action is successful. For example, the determination may be that the instruction to turn a value in a certain manner was successfully achieved but that the action itself did not correct the issue that caused the difference in step 823 to be unacceptable. If not successful in step 833, the process returns to step 827. Else, if successful, the process moves to step 825.

FIGS. 9A-9G depict illustrative screen displays of one or more dashboards in accordance with one or more aspects described herein. The dashboard may include or be a part of one or more graphical user interfaces of one or more applications that may provide information received from one or more sensors or determined based on analyzing information received from one or more sensors or via manual entry, according to one or more embodiments described herein. The dashboard may be displayed as part of a smartphone or tablet application (e.g., running on a remote device, such as remote device 1 or remote device 2).

Returning to FIG. 9A, the dashboard may provide data regarding the current mobile workflow being implemented 901. In this example, the mobile workflow is a maintenance workflow for gas pipeline #1A-XB2. Gas pipeline #1A-XB2 may be a particular gas pipeline in a particular area of a plant and the maintenance may be a scheduled maintenance check to ensure that the gas pipeline is operating correctly or may be a maintenance needed in response to an identified problem. Screen 3 of 8 is shown in FIG. 9A as 903. The displayed action may be an action to check the current gas pipeline pressure 905. Whether entered by a field worker or automatically received without field worker intervention, the current pressure is shown as 1000 lb/in² 907. If the current pressure reading was within bound values for the pressure for the gas pipeline #1A-XB2, then depression of the “Next Action” UI 909 may take the field worker to screen 4, as shown in FIG. 9G.

If the current pressure reading was outside bound values for the pressure for the gas pipeline #1A-XB2, then depression of the Next Action UI 909 in FIG. 9A may take the field worker to screen 3A 913 as shown in FIG. 9B. FIGS. 9B-9F are screens implemented (e.g., in real time or near real time) due to a modified mobile workflow. As shown in FIG. 9B, the dashboard may show a new message that there is a need to correct the current gas pipeline pressure 915 by adjusting the pressure down to below 700 lb/in² 917, e.g., to below the upper-bound value for the pressure accepted in gas pipeline #1A-XB2. The action in screen 3A is to identify the location 919 of value #VAL-2946 and for the field worker to acknowledge that she knows the location, depression of the “Next Step” UI 923, or that she indicates she needs instructions on finding the particular valve (#VAL-2946) identified, depression of the “Where's the Valve” UI 921.

Screen 3B 943 in FIG. 9C may show the dashboard upon the field worker depressing the “Next Step” UI 923 in FIG. 9B. This next action may be to turn value #VAL-2946 until the pressure is below 700 lb/in² 945. In one or more other embodiments, the action may be to adjust the pressure to a particular value and not just below an upper bound or threshold. The action in screen 3B also is for the field worker to acknowledge that she knows the direction or manner in which to turn the valve to lower pressure, depression of the “Next Step” UI 949, or that she indicates she needs instructions on which way or how to operate #VAL-2946 to lower the pressure, depression of the “Which Way Do I Turn Valve” UI 947.

Screen 3A_1 953 in FIG. 9D may show the dashboard upon the field worker depressing the “Where's the Valve” UI 921 in FIG. 9B. This next action may include a specific direction message 955 for the field worker to identify the location of the particular valve, #VAL-2496. Messages may be texted based, audio based, and/or video based to assist the field worker in identifying the location. In the example of FIG. 9D, the appearance 957 of the valve #VAL-2496 is shown in addition to text-based directional information based upon where the field worker is in the plant and what direction she is facing (which may be determined, e.g., based on a position or orientation of the device). The action in screen 3A_1 also is for the field worker to acknowledge that she has identified the location of valve #VAL-2496, depression of the “Next Step” UI, 961 or that she still cannot locate valve #VAL-2496, depression of the “Cannot Locate Valve” UI 959. If the “Cannot Locate Valve” UI 959 is depressed, one or more additional actions may be provided as additional screens and/or directional data to the field worker to assist as needed. For example, segments of the floor may be lit up (e.g., on a map displayed on the device, and/or via remote-controlled lights on the floor of the plant or refinery) to guide the field worker to the particular location of the valve.

Screen 3B_1 973 in FIG. 9E may show the dashboard upon the field worker depressing the “Which Way Do I Turn Valve” UI 947 in FIG. 9B. This next action may include an instruction message 975 indicating how to turn value #VAL-2946 to decrease the pressure. Messages may be texted based, audio based, and/or video based to assist the field worker in how to operate the valve. In the example of FIG. 9E, a video 977 showing turning valve #VAL-2496 in a direction away from the field worker's body may be shown in addition to text-based information. In some embodiments, an action (e.g., a light, LED, or signal may illuminate on, over, under, or near the valve) in the plant or refinery may occur in conjunction with a particular screen of the dashboard being displayed to help guide the user in taking an action (e.g., identifying a particular valve to turn). The action in screen 3E also is for the field worker to acknowledge that she turned the valve to lower pressure, depression of the “Next Step” UI 970.

Screen 3C 981 in FIG. 9F may show the dashboard upon the field worker depressing the “Next Step” UI 949 in FIG. 9C or 979 in 9E. The displayed screen may show that the corrective action was completed 983 with the current pressure at 650 lb/in² 985, e.g., below the upper bound of the acceptable pressure in gas pipeline #1A-XB2 987. Having completed the corrective action of the modified mobile workflow, depression of the “Next Action” UI 989 in FIG. 9F may take the field worker to screen 4 991 as shown in FIG. 9G, and back to the next actions of the original mobile workflow.

One or more features described herein may be embodied in a computer-usable data and/or computer-executable instructions, such as in one or more program modules, executed by one or more computers or other devices. Program modules may include routines, programs, objects, components, data structures, etc. that perform particular tasks or implement particular abstract data types when executed by a processor in a computer or other data processing device. The computer executable instructions may be stored on one or more computer readable media such as a hard disk, optical disk, removable storage media, solid state memory, RAM, etc. The functionality of the program modules may be combined or distributed as desired. In addition, the functionality may be embodied in whole or in part in firmware or hardware equivalents such as integrated circuits and/or field programmable gate arrays (“FPGA”). Particular data structures may be used to more effectively implement one or more features of the disclosure, and such data structures are contemplated within the scope of computer executable instructions and computer-usable data described herein.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps illustrated in the illustrative figures may be performed in other than the recited order, and one or more depicted steps may be optional in accordance with aspects of the disclosure. Accordingly, the foregoing description is by way of example only, and is not limiting.

What is claimed is:

1. A method comprising:
receiving, by a first computing device and from a second computing device, a mobile workflow representing a scheduled series of actions displayed by the first computing device and corresponding to a task associated with an asset of a petrochemical plant or refinery;
receiving, by the first computing device and from the second computing device, asset operation data representing one or more operating limits for a measurable element of the asset of the petrochemical plant or refinery;
initiating, by the first computing device, the mobile workflow by causing display of a first action of the scheduled series of actions;
after initiating the mobile workflow, receiving, by the first computing device and from a third computing device, current asset condition data representing a current operating condition for the measurable element of the asset of the petrochemical plant or refinery;
upon determining that a difference between the current operating condition for the measurable element of the asset and the one or more operating limits for the measurable element of the asset fails to meet the one or more operating limits for the measurable element of the asset, modifying, by the first computing device, the scheduled series of actions to include a corrective action to complete the task associated with the asset of the petrochemical plant or refinery; and
after modifying the scheduled series of actions, causing display, by the first computing device, of the corrective action, the corrective action comprising required one or more adjustments to the measurable element of the asset of the petrochemical plant or refinery.

2. The method of claim 1, wherein the received asset operation data is received periodically.

3. The method of claim 1, wherein the measurable element is a pressure value of the asset of the petrochemical plant or refinery.

4. The method of claim 1, further comprising determining the difference between the current operating condition for the measurable element of the asset and the one or more operating limits for the measurable element of the asset.

5. The method of claim 1, further comprising:
determining that the corrective action has been completed successfully; and
after determining that the corrective action has been completed successfully, causing display, by the first computing device, of a second action of the scheduled series of actions.

6. The method of claim 1, wherein the asset operation data representing the one or more operating limits comprises upper bound values and lower bound values for the measurable element of the asset.

7. The method of claim 1, wherein the asset operation data representing the one or more operating limits comprises a threshold value for the measurable element of the asset.

8. The method of claim 1, further comprising sending, by the first operating device, a request for the current asset condition data.

9. The method of claim 1, wherein the required one or more adjustments to the measurable element of the asset comprises instructions to ensure that the difference between a new current operating condition for the measurable element of the asset and the one or more operating limits for the measurable element of the asset meets the one or more operating limits for the measurable element of the asset.

10. The method of claim 1, wherein the first computing device receives the mobile workflow and the asset operation data wirelessly through a network, the second computing device operationally connected to the network.

11. A system comprising:
a first database configured to store a mobile workflow, the mobile workflow representing a scheduled series of actions a user of a first computing device utilizes to complete a task associated with an asset of a petrochemical plant or refinery;
a second database configured to store asset operation data, the asset operation data representing one or more operating limits for a measurable element of the asset of the petrochemical plat or refinery;
a third database configured to store current asset condition data, the current asset condition data representing a current operating condition for the measurable element of the asset of the petrochemical plat or refinery;
a mobile workflow platform comprising:
one or more first processors;
a first communication interface in communication with a mobile device, a first connector, and a second connector; and
first non-transitory computer-readable memory storing executable instructions that, when executed, cause the workflow platform to:
receive the mobile workflow from the first connector,
receive the asset operation data from the second connector,
transmit the mobile workflow to the mobile device, and
transmit the asset operation data to the mobile device;
the mobile device comprising:
one or more second processors;
a second communication interface in communication with the mobile workflow platform and the second connector; and
second non-transitory computer-readable memory storing executable instructions that, when executed, cause the mobile device to:
receive the mobile workflow from the mobile workflow platform,
receive the asset operation data from the mobile workflow platform,
initiate the mobile workflow by causing display of a first action of the scheduled series of actions,
receive the current operating condition from the second connector,
upon a determination that a difference between the current operating condition for the measurable element of the asset and the one or more operating limits for the measurable element of the asset fails to meet the one or more operating limits for the measurable element of the asset, modify the scheduled series of actions to include a corrective action the user of the mobile device utilizes to complete the task associated with the asset, and
cause display of the corrective action, the corrective action comprising required one or more adjustments to the measurable element of the asset;
the first connector comprising:
one or more third processors;
a third communication interface in communication with the mobile workflow platform and the first database; and
third non-transitory computer-readable memory storing executable instructions that, when executed, cause the first connector to:
receive the mobile workflow from the first database, and
transmit the mobile workflow to the mobile workflow platform; and
the second connector comprising:
one or more fourth processors;
a fourth communication interface in communication with the mobile workflow platform and the third database; and
fourth non-transitory computer-readable memory storing executable instructions that, when executed, cause the second connector to:
receive the current asset condition data from the third database, and
transmit the current asset condition data to the mobile device.

12. The system of claim 11, wherein transmitting the asset operation data to the mobile device comprises transmitting the asset operation data to the mobile device periodically.

13. The system of claim 11, wherein the second non-transitory computer-readable memory stores executable instructions that, when executed, further cause the mobile device to determine the difference between the current operating condition for the measurable element of the asset and the one or more operating limits for the measurable element of the asset.

14. The system of claim 11, wherein the second non-transitory computer-readable memory stores executable instructions that, when executed, further cause the mobile device to:
determine that the corrective action has been completed successfully; and
after determining that the corrective action has been completed successfully, cause display of a second action of the scheduled series of actions.

15. The system of claim 11, wherein the required one or more adjustments to the measurable element of the asset comprises instructions to ensure that a difference between a new current operating condition for the measurable element of the asset and the one or more operating limits for the measurable element of the asset meets the one or more operating limits for the measurable element of the asset.

16. A method comprising:
receiving, by a first computing device and from a second computing device, a mobile workflow representing a scheduled series of actions a user of a mobile computing device utilizes to complete a task associated with an asset of a petrochemical plant or refinery;
sending, by a first computing device and to the mobile computing device, the mobile workflow;
receiving, by a first computing device and from a third computing device, asset operation data representing one or more operating limits for a measurable element of the asset of the petrochemical plant or refinery;
sending, by the first computing device and to the mobile computing device, the asset operation data;
sending, by the first computing device and to the mobile computing device, current asset condition data representing a current operating condition for the measurable element of the asset of the petrochemical plant or refinery;
receiving, from the mobile computing device, data representative of a modification to the scheduled series of actions of the mobile workflow to include a corrective action the user of the mobile computing device utilizes to complete the task associated with the asset of the petrochemical plant or refinery; and
receiving, from the mobile computing device, confirmation that the corrective action has been completed successfully.

17. The method of claim 16, wherein the asset operation data is sent periodically, and the current asset condition data is sent after a request for the current asset condition data is received by the first computing device.

18. The method of claim 16, wherein the measurable element is a pressure value of the asset of the petrochemical plant or refinery.

19. The method of claim 18, wherein the mobile workflow is a maintenance workflow, and the data representative of the modification to the scheduled series of actions of the mobile workflow to include the corrective action the user of the mobile computing device utilizes to complete the task associated with the asset comprises data representative of an adjustment to the pressure value of the asset.

20. The method of claim 16, wherein the asset operation data representing the one or more operating limits comprises at least one bound value for the measurable element of the asset.
